(19) United States
(12) Patent Application Publication
(10) Pub. No.: US 2013/0130784 A1
(43) Pub. Date: May 23, 2013

(54) SYSTEM AND METHOD FOR PRODUCT-BASED GAMING

(71) Applicant: Mahoot, Inc., Palo Alto, CA (US)

(72) Inventors: Randi Kofman, Lafayette, CA (US); Linda Hirshhorn Pouliot, San Mateo, CA (US); Evan John Gridley, Sunnyvale, CA (US)

(73) Assignee: Mahoot, Inc., Palo Alto, CA (US)

(21) Appl. No.: 13/673,907

(22) Filed: Nov. 9, 2012

Related U.S. Application Data
(63) Continuation-in-part of application No. 13/293,020, filed on Nov. 9, 2011.
(60) Provisional application No. 61/557,782, filed on Nov. 9, 2011.
(60) Provisional application No. 61/493,357, filed on Jun. 3, 2011.

(51) Int. Cl. G07F 17/32

(52) U.S. Cl. CPC G07F 17/323; G07F 17/3258
USPC 463/25; 463/42

(57) ABSTRACT

Disclosed are new approaches for providing a product based game. A host may receive a user selection of one or more products. Products may be selected by scanning optical codes using a camera or other device. According to an outcome of the game, one or both of a product and a promotional offer are selected, including discounts and these are communicated to the user. Graphical representations of the one or more products selected by the user may be used as interface elements in a game interface. In some embodiments, a multi-player game may be initiated from a social networking interface and invitations issued to users linked to an inviter's networking interface. A player may pay a fee to buy points or for the privilege of playing. In some embodiments, the promotional offer is a discount and the discount amount is at least as great as a game fee.

### RELATED APPLICATIONS

This application claims priority to U.S. Provisional Application Ser. No. 61/557,782 filed Nov. 9, 2011 and entitled ONLINE SHOPPING/GAMING, which is hereby incorporated herein by reference in its entirety.

This application is also a continuation in part of U.S. application Ser. No. 13/293,020 filed Nov. 9, 2011 and entitled SYSTEM AND METHOD FOR PRODUCT-BASED GAMING, which claims priority to U.S. Provisional Application Ser. No. 61/493,357 filed Jun. 3, 2011, and entitled ONLINE SHOPPING/GAMING, both of which applications are hereby incorporated herein by reference in their entirety.

### BACKGROUND

The internet has become a primary resource for entertainment. Many popular sites offset internet-based games and videos. Typically such sites are advertisement supports or require payment of a subscription fee. However, banner ads and other forms of advertisements displayed in a browser are easily ignored. Accordingly, the “click-through” rate for such advertisements is extremely low.

Many people also use the internet for shopping including both purchasing products from websites and researching products they wish to buy. The abundance of shopping sites makes it difficult to attract customers. In addition, the browsing habits of many users include only looking at a merchant's website for a matter of seconds before moving on to another site or navigating to another portion of a merchant's website.

In view of the foregoing it would be an advancement in the art to provide an approach to internet shopping and advertising that is able to attract customer's attention as well as providing the entertainment that many internet users seek.

### DESCRIPTION OF THE DRAWINGS

The specific features, aspects and advantages of the present invention will become better understood with regard to the following description and accompanying drawings where:

FIG. 1. is a schematic block diagram of a computing device suitable for use in accordance with an embodiment of the present invention;

FIG. 2. is a schematic block diagram of a networking environment suitable for use in accordance with an embodiment of the present invention;

FIG. 3. is a process flow diagram method for providing a product-based game in accordance with an embodiment of the present invention;

FIG. 4. is a schematic block diagram of a network profile interface suitable for launching a product based game in accordance with an embodiment of the present invention;

FIG. 5. is a process flow diagram of a method for providing a product-based game in the context of a social networking system in accordance with an embodiment of the present invention;

FIG. 6. is a process flow diagram of a method for interfacing a product-based game with a merchant providing products for use in the product-based game in accordance with an embodiment of the present invention;

FIGS. 7A and 7B are illustrations of interfaces for a product-based game in accordance with an embodiment of the present invention;

FIG. 8. is a process flow diagram of a method for setting up a product-based game in accordance with an embodiment of the present invention;

FIG. 9. is a process flow diagram of a method for joining a product-based game in accordance with an embodiment of the present invention;

FIG. 10. is a process flow diagram of a method for initiating a product-based game interface in accordance with an embodiment of the present invention;

FIG. 11. is a process flow diagram of a method for managing player interactions in a product-based game in accordance with an embodiment of the present invention;

FIG. 12. is a process flow diagram of a method for managing a player's turn in a product-based game in accordance with an embodiment of the present invention;

FIG. 13. is a process flow diagram of a method for managing exchange of products in a product-based game in accordance with an embodiment of the present invention;

FIG. 14. is a process flow diagram of a method for holding a product in a product-based game in accordance with an embodiment of the present invention; and

FIG. 15. is a process flow diagram for presenting and redeeming product discounts in a product-based game in accordance with an embodiment of the present invention.

FIG. 16. is a process flow diagram for performing a branded product-based game in accordance with an embodiment of the present invention.

FIG. 17. is a process flow diagram for awarding promotions for participation in product-based games in accordance with an embodiment of the present invention.

FIG. 18. is a process flow diagram of a memory game suitable for use in a product-based game in accordance with an embodiment of the present invention.

FIG. 19. is a process flow diagram of a domino type game suitable for use in accordance with an embodiment of the present invention.

FIG. 20. is a diagram of tiles played in a domino type game in accordance with an embodiment of the present invention.

FIG. 21. is a process flow diagram of a method for providing a product-based sequence game in accordance with an embodiment of the present invention.

FIG. 22. is a diagram of an interface for a product-based sequence game in accordance with an embodiment of the present invention.

FIG. 23. is a process flow diagram of a method for providing another product-based sequence game in accordance with an embodiment of the present invention.

FIG. 24. is a process flow diagram of a method for providing yet another product-based sequence game in accordance with an embodiment of the present invention.

FIG. 25. is a process flow diagram of a method for providing a product-based telephone game in accordance with an embodiment of the present invention.

FIG. 26. is a process flow diagram of a method for providing another product-based telephone game in accordance with an embodiment of the present invention.

FIG. 27. is a process flow diagram of a method for providing a product-based Sudoku game in accordance with an embodiment of the present invention.

FIG. 28. is a process flow diagram of a method for providing a product-based warehouse game in accordance with an embodiment of the present invention.

FIG. 29. is a diagram of an interface for a product-based warehouse game in accordance with an embodiment of the present invention.

FIG. 30. is a process flow diagram of a method for providing a product-based slide game in accordance with an embodiment of the present invention.

FIG. 31. is a diagram of an interface for a product-based slide game in accordance with an embodiment of the present invention.

FIG. 32. is a process flow diagram of a method for providing a product-based matching game in accordance with an embodiment of the present invention.

FIG. 33. is a diagram of an interface for a product-based matching game in accordance with an embodiment of the present invention.

FIG. 34. is a process flow diagram of a method for providing a branded product-based game in accordance with an embodiment of the present invention.

FIG. 35. is a process flow diagram of a method for providing another branded product-based game in accordance with an embodiment of the present invention.

FIG. 36. is a process flow diagram of a method for providing yet another branded product-based game in accordance with an embodiment of the present invention.

### DETAILED DESCRIPTION OF THE PREFERRED EMBODIMENT

In the following description of the preferred embodiment of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning networks, interfaces, computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . .”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The following description relates to methods for providing product-based gaming. A user may select a product or products and may also provide a ranking of a list of products. The products may be selected by scanning optical codes, such as by means of a camera provided on a smart phone or other portable computing device. A host receives the selection of a product or products and possibly a ranking. The host then manages interaction with the user to provide game play. According to an outcome of the game, the host selects one or both of a product and a promotion, which may include a discount amount, and presents one or both of these to the player. In some embodiments, images of the one or more products selected by the user are used as interface elements in the game. The player may pay a fee to play the game and the promotion may include a discount amount chosen to be at least as great as the fee. Upon redemption of the promotion, a merchant may pay a fee to an entity providing the product-based game.

Various additional features and alternative embodiments are disclosed herein, including various games suitable for use in accordance with the disclosed systems and methods

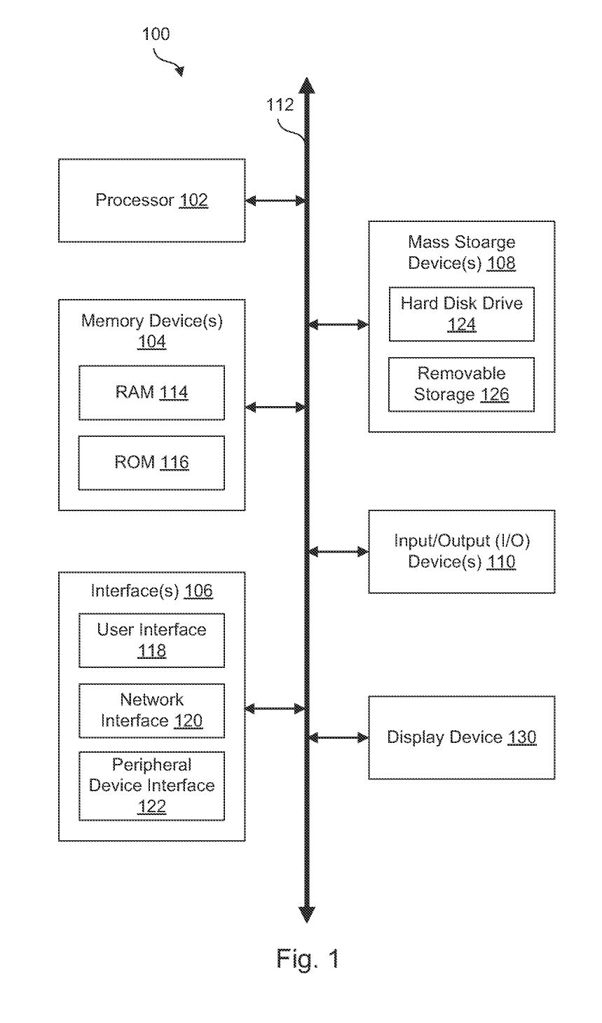

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

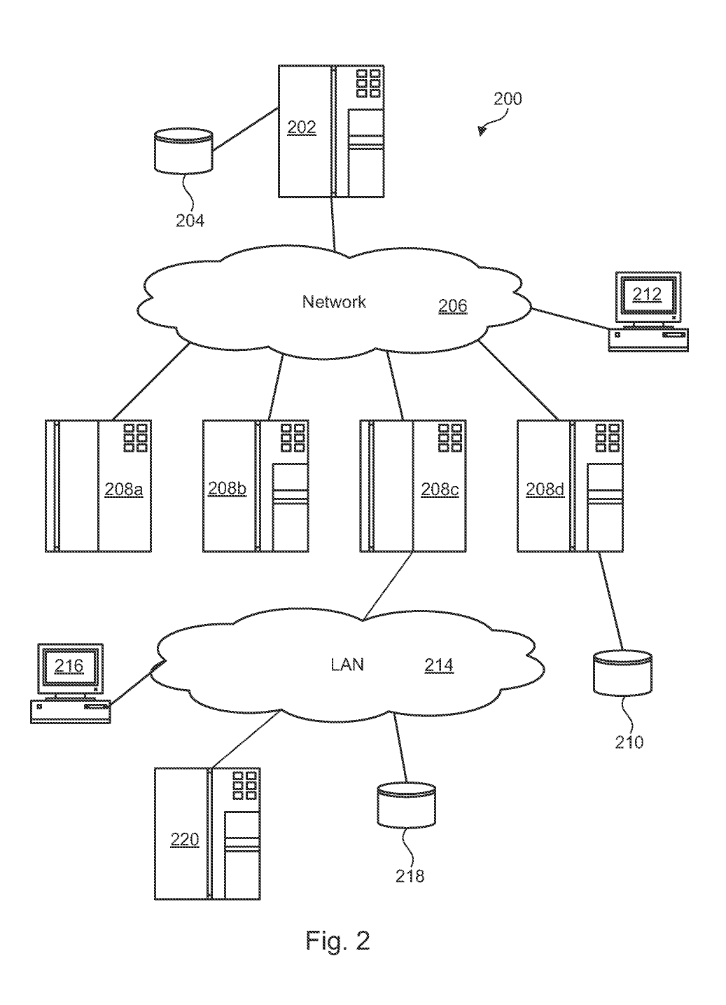

FIG. 2 is a block diagram illustrating an example operating environment 200, including a host server 202 operably coupled to a build database 204. The host server 202 and other components of the environment 200 may be embodied as the computing device 100 and include some or all of the components illustrated in FIG. 1. The database 204 may be a memory device, such as a hard drive, operably coupled to the host server 202 or may be another computing device 100 communicatively coupled to the host server 202. The host server 202 may be coupled to a network 206 such as a LAN, WAN, or the Internet. One or more additional servers 208a-208d may also be operably coupled to the network 206. The servers 208a-208d may host build systems or may provide application subscription services as described hereinbelow. The servers 208a-208d may also provide other services including custom services programmed by an end user. In some embodiments, the host server 202 may also provide an application subscription service as described hereinbelow. One or more of the servers 208a-208d may be operably coupled to a database 210 to facilitate provision of an application subscription service.

One or more workstations 212 may be operably coupled to the host server 202 or one or more of the servers 208a-208d, such as by means of the network 206. The workstation 212 may be used by a user wishing to access the services provided by the servers 208a-208d or host server 202. The workstation 212 may host a browser for presenting a web-based interface to processes running on the servers 208a-208d or host server 202. The workstation 212 may be embodied as a computing device such as that illustrated in FIG. 1. The workstation 212 may be a desktop, laptop, or tablet computer. The workstation 212 may also be embodied as a smart phone, tablet computer, or other portable computing device.

One or more of the servers 208a-208d may be coupled to a local area network (LAN) 214 having one or more of additional workstations 216, databases 218, and servers 220. In such embodiments, the server 208c coupled to the LAN may provide a gateway to a system seeking to access resources provided on the workstation 216, database 218, or server 220. Accordingly, the services “provided” by the server 208c may include those provided components coupled to the LAN 214 and accessed by means of the server 208c.

In some embodiments, the host server 202 may provide product-based gaming for users on one or more workstations 212. The servers 208a-208d may provide internet purchasing interfaces for users wishing to purchase products featured in a product-based game provided by the host server. For purposes of this disclosure a “product” may be anything that may be purchased with money including goods, services, and any and all intangible property.

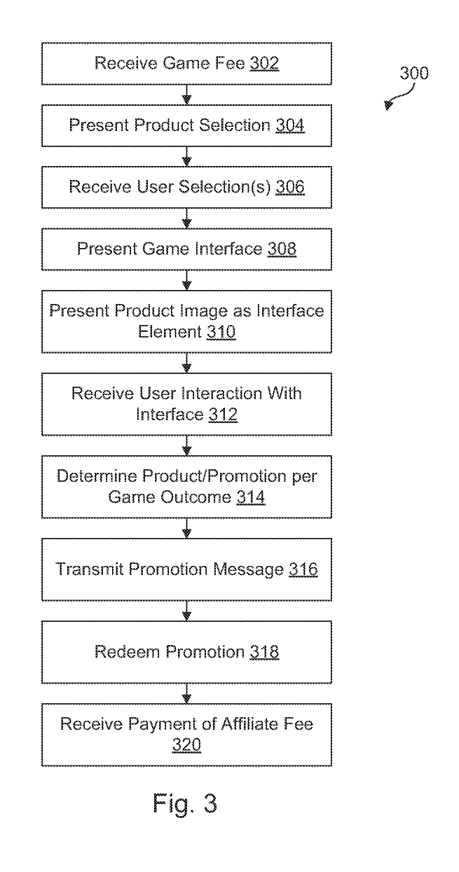

FIG. 3 illustrates a method 300 for providing product-based gaming suitable for the operating environment 300. The method may include receiving 302 a game fee from one or more prospective players. Receiving 302 the game fee may be performed by a financial institution or the like and may include transmitting a verification of receipt of the game fee to the host server 202. The game fee may be very small and in some embodiments, the fee may be omitted entirely or omitted during a trial period of the gaming system described herein.

A prospective player may also be presented 304 with a product selection on the workstation 212. The product selection may include products from one or more merchants and may be navigable and searchable as known in the art of online shopping. Presenting 304 may include presenting 304 the product selection in a web browser or embedded in a game interface. The products may be represented with images and/or text and may be presented with additional information such as customer reviews and links to related products. The prospective player chooses products from the product selection and these choices are transmitted to the host server 202. The host server receives 306 the prospective player's choices, in the form of product identifiers for the selected products. In some embodiments, prospective players may rank multiple products in order of preference. Accordingly, receiving 306 the prospective player's choices may include receiving a ranking for the products chosen.

In some embodiments, a user does not select products and is not presented with an opportunity to select products. For example, a user may simply be presented with an invitation to play a game for the opportunity to win a promotion, such as a discount, for a pre-determined product.

The host server 202 may then present 308 a game interface to one or more prospective players. The game interface may be a locally executed application. In such embodiments, presenting 308 the game interface may include transmitting an authorization or instruction to the local interface to present the game interface upon payment of the game fee and selection of one or more products. Alternatively, the game interface may be a web-based interface such that presenting 308 the game interface may include transmitting a web page operable to provide a game interface when rendered by a browser. Presenting 308 the game interface may include presenting 310 images of one or more produces selected by a player as interface elements. For example, game pieces, buttons, and other elements that a user may manipulate using a mouse may be displayed on the user workstation with an image of a selected product.

The game interface receives 312 user interactions therewith. For web based applications, receiving 312 user interactions may include receiving 312 these interactions at the host server 202 as transmitted from a web-based application or browser executing on the workstation 212. The host server 202 may interpret the user interactions and update the state of the game and transmit any updates to the game interface to the user workstation 212. For locally executing, applications, the locally executing application receives 312 the user interactions and updates the state of the locally executing game and locally presented game interface as necessary.

Upon conclusion of the game, the method 300 includes determining 314 which product and/or promotion or discount the player receives according to the outcome of the game. In some embodiments, the discount is fixed and the product is selected according to the outcome of the game. In some embodiments, an awarded promotion may include buy one, get one deals, gifts with purchase of a prize product, access to limited supply goods, access to events, access to special content, and the like. In other embodiments, the product is always one of the products selected by the player but the amount of the discount or type of promotion depends on the outcome of the game. In still other embodiments, the product and the promotion, such as a discount amount, are selected based on the outcome of the game. In embodiments where a fee is paid to play the game, the value of the promotion or amount of the discount is preferably greater than or equal to the amount of the game fee. In some embodiments, the product and/or promotion are selected by a random process where the likelihood of receiving one of the products selected by the player and/or a larger valued promotion, e.g., discount amount, increases based on the outcome of the game, i.e., number of points, win or loss, completion of a task, or the like. In embodiments, where users select products and rank them in terms of desirability, the likelihood that the user will receive a promotion, such as a discount, for a higher ranked product may increase based on the outcome of the game. For example, a larger number of points may increase the likelihood of getting a higher ranked product. The step of determining 314 the prize product and/or promotion may be performed by the host server 202 or by an application executing on the workstation 212.

A promotion message may then be transmitted 316 to the player, such as by transmitting a message to the workstation 212 by means of a web browser, email application, text message, or interaction with another locally executing application on the workstation 212. The promotion message may identify the prize product determined at step 314 and the promotion, such as a discount amount. The promotion message may further include a time limiter indicating how long the promotion will be available or providing other incentives to redeem the promotion in a timely manner. Other incentives may include promotions for accessories for the prize product that expire if not redeemed by a given time or an additional discount for the prize product that expires unless the promotion is redeemed by a given time. In addition to any incentives, offers, advertisements, and discounts, or other promotions for other products, which may relate to the prize product, may also be included in the promotion message. The promotion message may include a promotional code, electronic coupon, or other data enabling the player to redeem the promotion for the prize product at a website or physical store of a merchant.

Upon redemption of the promotion for the prize product by the player, the merchant that sold the product to the player may remit an affiliate fee or other compensation to the entity owning or controlling the host server 202. Accordingly the method 300 may include receiving 320 payment of an affiliate fee. The fee may be paid to a financial institution such that receiving 320 payment of the affiliate fee may include receiving 320 notice of payment of the affiliate fee. In some embodiments, a merchant providing products for selection using the method 300 may pay a sponsorship fee such that payment of an affiliate fee upon redemption of a promotion message is not performed.

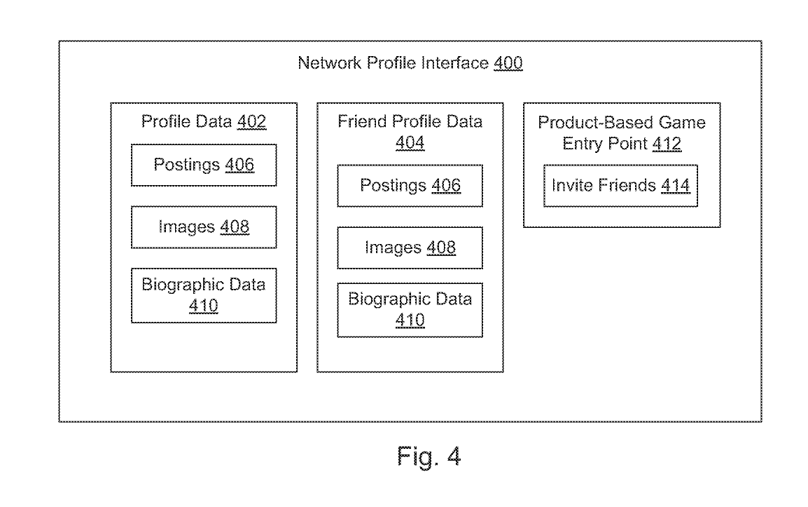

FIG. 4 illustrates a network profile interface 400 that may be used for launching a product-based game as described above with respect to FIG. 3. The network profile interface 400 may be an interface to a social or professional networking site such as Facebook, Linkedin, Myspace, Twitter, or the like. The network profile interface 400 may be presented in a browser and may reflect data stored in a database accessed by means of a server, such as one of the servers 208a-208d. The network profile interface 400 may display profile data 402 for a user profile data 404 for one or more friends linked to the user's profile. The profile data 402, 404 may include postings 406 of text, images 408, and other biographic data 410.

The network profile interface 400 may additionally display an entry point 412 to launch a product-based game, such as described above with respect to FIG. 3. The entry point 412 may be a hyper text link, linked image, button, or other user interface element. The entry point 412 may include an interface element 414 allowing a user to invite friends, such as friends having their profile data 404 linked to the user's profile data 402 to join in a product-based game.

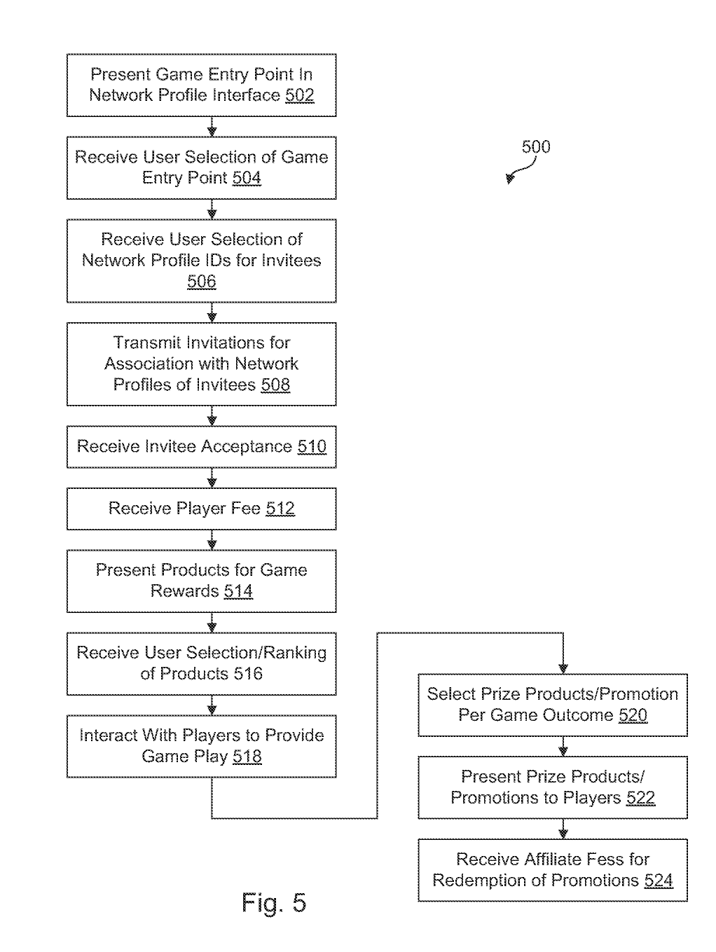

FIG. 5 illustrates a method 500 for initiating and managing a product-based game using a network profile interface 400. The method 500 may include displaying 502 an entry point 412 for a product based game in a network profile interface 400 of a prospective player. The entry point may be a button, link, or any other user interface element. The entry point may be linked to a host server 202 such that interaction by a user with the entry point instructs the host server to take actions necessary to initiate a product based game. In some embodiments, the method 500 may also be executing using a social networking interface. Other network interfaces such as email and the like may also be used to perform the method 500.

The method 500 may include receiving 504 a user selection of the game entry point. This may include receiving a message at a host server 202 as a result of user selection of the game entry point on a workstation 212. The method 500 may further include receiving 506 a user selection of network profile identifiers and transmitting 508 invitations to join in a group game to the identified users.

Various methods may be used to receive 506 a selection of invitees and transmit 508 the invitations to the invitees using a social networking interface. An inviter player may, for example, select invitee players from a contact list or friends list including identifiers for the network profiles of other users and then issue invitations to an inbox or other messaging data structure of a social networking profile of an invitee player using communication methods known in the art of social networking. The invitation may include hyptertext, buttons, or other user interface elements allowing the invitee player to click on the invitation when viewed in the network profile interface to indicate to the host server 202 an acceptance of the invitation. The invitation may be generated by the host server 202 and transmitted by means of the host server 202. For example, a locally executing application or interface to an application executing on the host server 202 may receive identifiers for prospective players and transmit invitations with required codes or user interface elements to the inbox of the invitee player's networking profile.

Alternatively, the invitation may include a game identifier. The invitee player may then transmit the game identifier to the host server 202 identifier upon initiation a game, such as by performing steps 502 and 504 using a network profile interface. The game identifier may be supplied by the user to the host server 202 upon initiating the game by performing steps 502 and 504. Alternatively, the game identifier may be transmitted from the host server 202 to the user's inbox upon performance of the steps 502 and 504. In some embodiments, invitations including a link, game identifier, or other access code, may be transmitted by email, text message, or the like, and accepted in the same manner as described above.

The host server 202 may receive 510 acceptances from one or more of the invitees. As noted above, acceptance may be initiated by an invitee may clicking a link in the invitation or by selecting a game entry point and entering a game identifier or other code in a game interface presented on the invitee computer. In embodiments where payment of a game fee is required the host server 202 may receive 512 payment of a game fee. As noted above, this may include receiving at the host server notification of payment of a game fee by a financial institution or other payment processing entity.

The method 500 therefore includes steps of presenting 514 products for game rewards on the user computers, and receiving 516 user selections of one or more desired products, which may include a ranking of the desired products. Interacting 518 with the players to provide the game play may be through a web browser executing on each of the inviter and invitee computers or an independent application. Interaction 518 between players may be managed on the host server 202 in data communication with the user computers or may be performed by the user computers with interaction achieved by communication between user computers.

The method 500 may include selecting 520, by the host server 202 or an application executing on the player computers, one or both of a prize product and a promotion, such as a discount amount, according to the outcome of the game. In some embodiments, selection 520 of a prize may be as described hereinabove except that the prize product selected 520 for an individual player may be any of the products selected by any of the other players of the group. Alternatively, the pool of products from which the prize product is selected 520 may include those of some or all of the players in the group as well as one or more other products that were not selected by any of the players. As already noted hereinabove, in embodiments where a game fee is required to play the value of the promotion, such as the value of a discount, is preferably at least as great as the game fee. The prize product and promotion may then be presented 522 to the players. Upon redemption of one or more of the promotions, the host server 202 may receive 524 or verify receipt of an affiliate fee from the merchant providing the prize product and promotion.

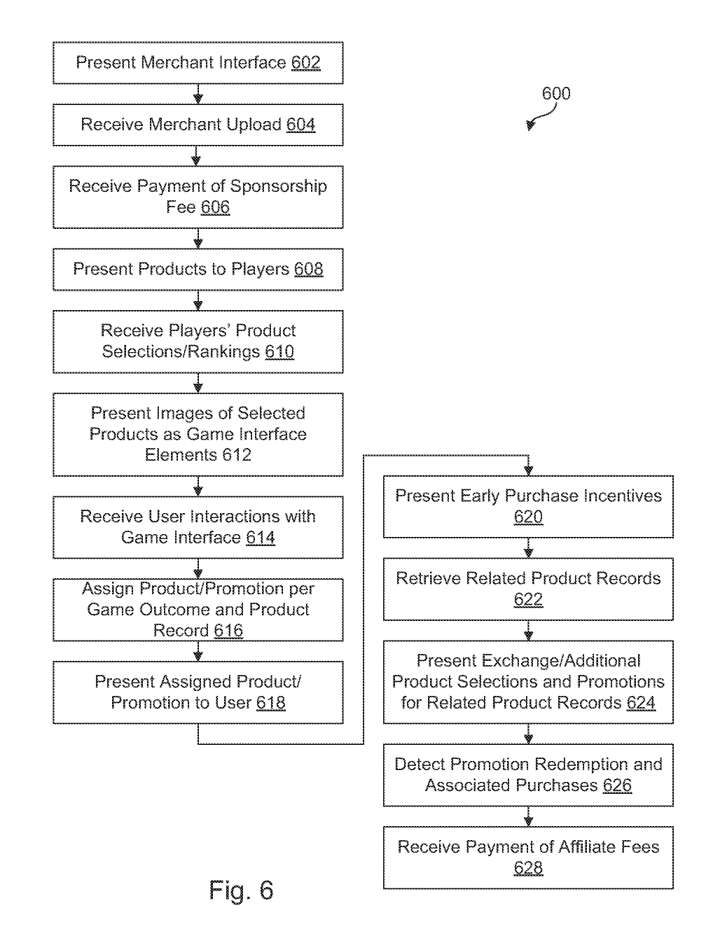

FIG. 6 illustrates a method 600 for obtaining products for use in a product-based game from a merchant. The method 600 may include presenting 602 an interface to a merchant. The interface may be graphical interface presented in a browser executing on a workstation 212 associated with a merchant. Alternatively, the interface presented may be a network interface available for communication with a merchant computer according to a protocol. The host server may receive 604 an upload from the merchant. The upload may include product records identifying one or more items of information such as a consumer identifiable product name, a product code such as a UPC, a permitted discount amount or range of permissible discount amounts, one or more promotion parameters (e.g., buy one get one, free gift, etc.), a price, a expiration date after which the product will no longer be available for use in a product-based game, and like information. The information receive 604 may also include information establishing a merchant account such as a merchant identifier and password, payment information for paying sponsorship or affiliate fees, and the like.

The method 600 may further include receiving 606 payment of a sponsorship fee. In some embodiments, receiving 606 payment of the sponsorship fee may include receiving verification of payment of the fee from another entity, such as a financial institution. The sponsorship fee may be a fee paid in order for the host server 202 to provide the merchant's product's as part of the product-based game and may also include a fee for providing advertising, e.g., banner ads, as part of a game interface. Where a merchant has a paid up sponsorship fee or a fee is otherwise not required, the step of receiving 606 payment of the sponsorship fee may be omitted.

The products received 604 from a merchant may then be presented 608 to players for selection as part of a product-based game. The products presented 608 may include those received 604 from multiple merchants. As noted above, presenting 608 products to players may include providing a web-based interface that is navigable and searchable. As in the other methods described herein, the method 600 may include receiving 610 a player's selection of one or more products from the interface for each player. Receiving 610 a player's selection may include receiving multiple products along with a ranking of the selected products.

The method 600 may include providing game play to one or more players. This may include presenting 612 one or more of a player's selected products as interface elements in a game interface and interacting 614 with one or more players to provide game play. In some embodiments, steps 612 and 614 may be performed by a software module executing on a user workstation 212.

Upon conclusion of the game, a player may be assigned 616 one or both of a product and a product promotion, such as a discount amount, based on the outcome of the game. The product assigned and the promotion may be defined by product records received 604. The product and/or promotion assigned 616 may then be presented 618 to the player. Presenting 618 the promotion may include transmitting a promotion message identifying the product and/or promotion to a workstation 212 associated with a user.

The method 600 may include presenting other information to the user along with the promotion message. This may include presenting 620 early purchase incentives. The purchase incentives may include free products for purchase by a deadline, additional promotions for the prize product, and the like. The method may also include retrieving related product records 622 and presenting 624 the retrieved products along with discounts or offers to purchase the retrieved products. As in other steps of the method 600, presenting may include transmitting the information to a user workstation 212.

The method 600 may further include detecting 626 redemption of any promotions or product offers presented in steps 618, 620, or 624. Detecting 626 may include receiving notice from a merchant that uploaded a record for the product redeemed that a product associated with one of the products offered in steps 618, 620, or 624. The method may also include receiving payment 628 of an affiliate fee, which may include receiving notice of payment of the affiliate fee from a financial institution.

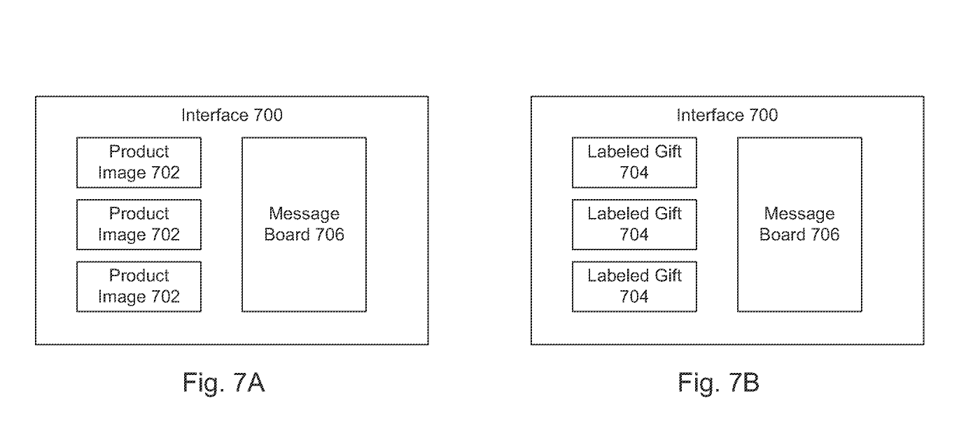

FIGS. 7A through 15 illustrate an interface and flow diagrams for an example of a product-based game. The illustrated game may is a “white elephant” type game. Referring specifically to FIG. 7A, one or more players select products and graphical representations of these products are presented as user interface elements 702. The user interface elements 702 may include other products not selected by any of the users. Referring to FIG. 7B, during game play, the interface elements 702 may be replaced with wrapped representations 704 that obscure the identity of the products. The wrapped representations 704 may be labeled with the name of the player to which they correspond. One of the wrapped representations 704 may correspond to a white elephant gift that was not picked by any of the players but which is nonetheless labeled with the name of one of the players to obscure its identity. The interface 700 may further include a message board 706 for posting messages during game play as described hereinabove.

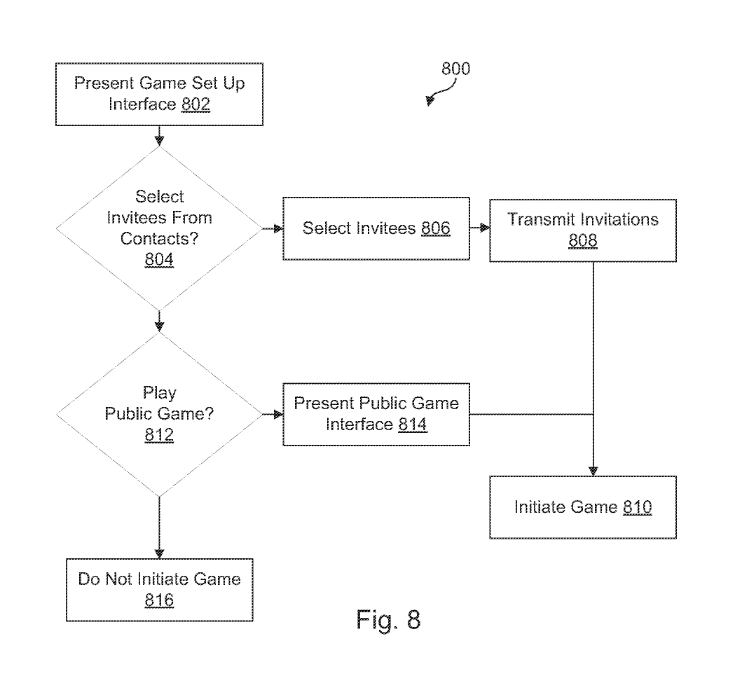

FIG. 8 illustrates a method 800 for initiating a game, such as a product-based game or a product-based white elephant type game. The method 800 may be used with a social networking system and may be integrated with a social networking profile interface. The method may include presenting 802 a game setup interface. Presenting 802 may include defining an interface for presentation on a social networking profile interface viewed by an inviter player. The method 800 may include determining 804 whether a player intends to add invitee players from contacts associated with the player's social networking profile. This may include receiving a user input such as a mouse click on a button or other interface element. If the player intends to invite contacts to play, then the player selects 806 invitees from those associated with the profile and these invitees are received by the host server 202. The invitations are than transmitted 810 to the invitees and the game is initiated 810. The method 800 may include evaluating 812 whether the user intends to play a public game. This may include evaluating 812 whether a user has clicked or otherwise interacted with a user interface element indicating intent to play a public game. If so, then the user may be presented 814 with a public game interface and the game may be initiated 810. The public game interface may be presented along with the social networking profile interface. A public game may be initiated when a minimum number of players have chosen to play a public game. If the user does not intend to select invitee players from contacts or play a public game, then the method 800 may refrain 816 from initiating a game.

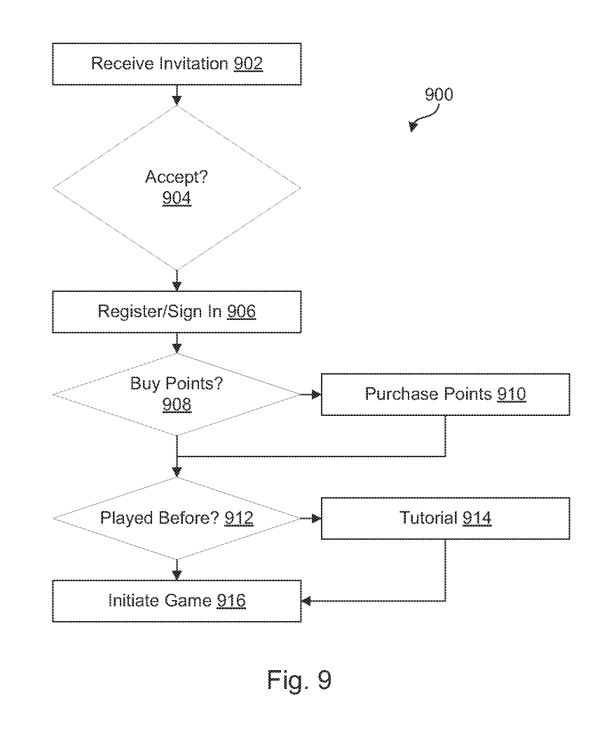

FIG. 9 illustrates a method 900 for adding an invitee and inviter to a game. The method 900 may be executed following execution of the method 800 as part of initiating 810 a game. The method 900 may include receiving 902 an invitation, for the case of an invitee. The invitation may be received by associating the invitation with the invitee's social networking profile such that the invitation is visible when the invitee is viewing the social network profile interface. The invitee's acceptance of the invitation may be evaluated 904. This may include whether the user has clicked or otherwise interacted with a link, button, or other user interface element. If the invitee accepts the invitation, the user may register and/or sign in 906 to the game. This may be performed automatically upon acceptance automatically or may require the invitee to enter a user name and password or generate a new user account with a user name and password. An inviter may also sign in or register.

The method 900 may include evaluating 910 whether a user wishes to buy points. If so, then the host server 202 manages interactions required for the user to transfer money to the entity owning or controlling the host server and associates points with the purchaser of the points. The method 900 may also include evaluating 912 whether a prospective player has played before. If not, then the host server 202 may present 914 a tutorial to the player. In either case, a game is then further initiated 916.

The following figures and description describe the logic of providing a white elephant type game. The method steps described may be executed on the host server 202, on a player workstation 212, a combination of the two, or by some other device alone or in combination with these devices. Interaction and instructions from players may be received and processed on a player workstation 212 or received on the player workstation 212 and transmitted to the host server 202 for processing.

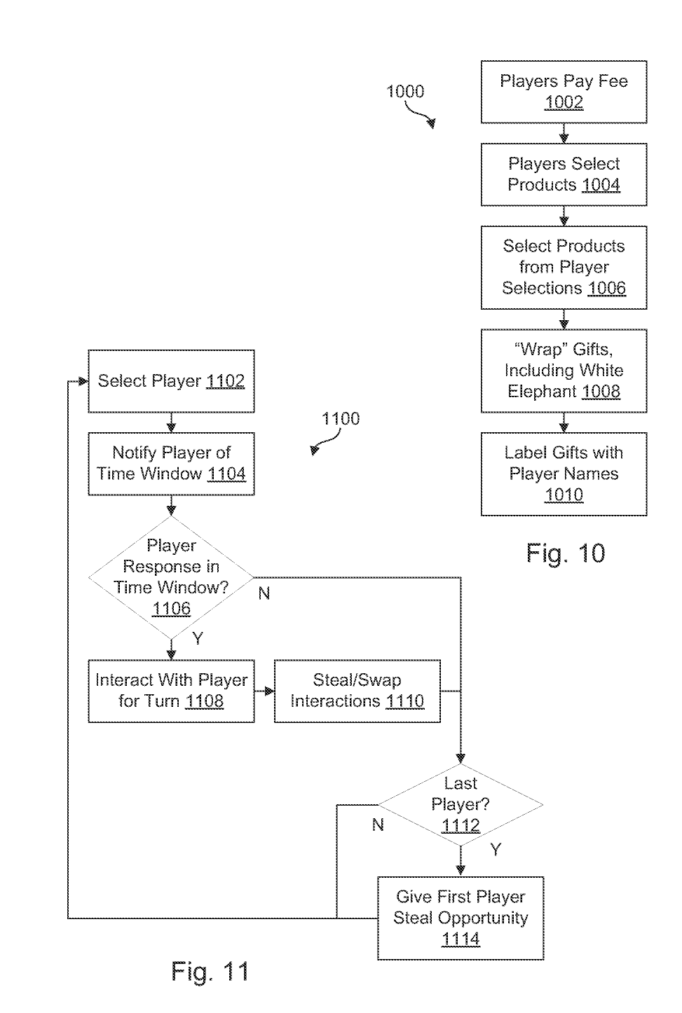

A game may begin with execution of a method 1000 of FIG. 10. The method 1000 may be executed after the methods 800 and 900. The method 1000 may include receiving 1002 player fees and receiving 1004 the player selections of products for each of the players as described hereinabove. The method 1000 may then include selecting 1006 products from among the products selected by each player. In some embodiments, one product may be selected 1006 from each player's selections. Each of the gifts selected at step 1006 may be wrapped 1008, this may include presenting interface elements representing the products with symbols that do not reveal the identity of the products. One of the wrapped gifts may include a white elephant gift. The white elephant gift may include an undesirable product, no product at all, or a randomly selected product. In some embodiments, the wrapped gifts may be labeled 1010 with player's names. The player's name labeling a gift may correspond to the player that selected the gift, except for the white elephant gift. Labeling may include displaying the player's name on or by an interface element representing a gift.

FIG. 11 illustrates a method 1100 outlining game play for a white elephant type game. A player is selected 1102 from among the players associated with the game and the selected player is notified of a time window for completing and/or commencing the player's turn. If the player is found 1106 to have responded within the time window, the method 1100 includes interacting 1108 with the player and managing 1120 stealing and swapping interactions between players during the player's turn, such as is described in greater detail below. If the selected player is found 1112 not to be the last player than another player is selected 1102. If the selected player is found 1112 to be the last player, than the player first selected to take a turn is given 1114 an opportunity to steal a gift from any other player. Some exceptions to this may be permitted, for example, if another player has paid a lock fee or has immunity from stealing, stealing by the first selected player may not be permitted in some embodiments.

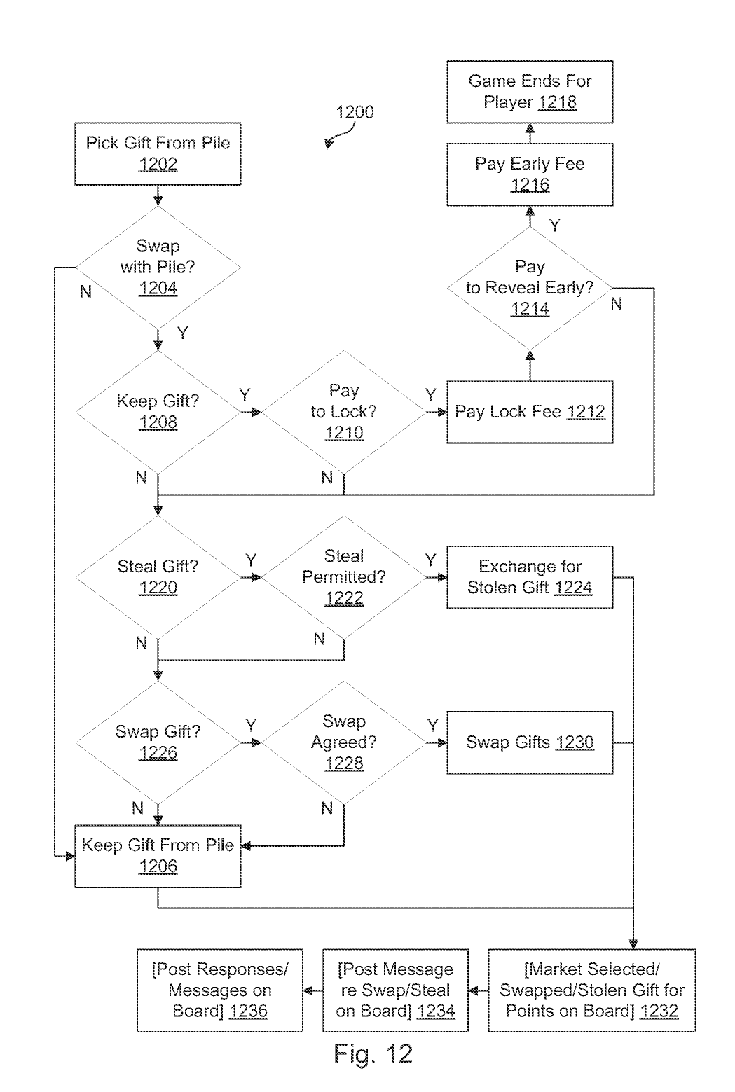

FIG. 12 illustrates a method 1200 for conducting a player's turn in a white elephant type game. A player's turn may include picking 1202 a gift from a pile of gifts. The contents of the gifts may be obscured and may include gifts selected by each player as described in the methods hereinabove. The gifts may also include a white elephant gift which may correspond to no product at all, an undesirable product, or a randomly chosen product. Upon picking the gift, the product corresponding to the picked gift may be revealed to the player and possibly to the other players.

The player may then choose 1204 whether to swap the gift with another gift from the pile. If not, the player will keep 1206 the gift from the pile. If so, then the player swaps gifts with the pile and has an option to keep the gift swapped from the pile may choose 1208 whether to keep the second gift from the pile, after finding out the product associated with the second gift. If the player chooses to keep the gift, then the user may choose 1210 to pay a lock fee to prevent loss of the gift during later game play. If the player chooses to pay a lock fee then the lock fee is paid 1212 and received by the entity associated with the host server. The player may also choose 1214 whether to pay an early fee. If the player chooses 1214 to pay the fee, then the fee is paid 1216 and the game ends 1218 for that player.

If a player chooses 1208 not to keep a gift selected from the pile on that turn, the player may choose 1220 to steal a gift from another player. If so, then the method 1200 may include evaluating 1222 whether steal is permitted according to game logic described hereinbelow. If so, then the gift associated with the player is exchanged 1224 with a gift associated with another player chosen by the player. A player may choose 1226 to swap gifts with another player rather than to steal a gift. If the other player is found 1228 to agree with the swap, then the player and the other player exchange 1230 gifts. This may include changing the gifts associated with each player's game state.

In some embodiments, a message board as known in the art may be accessible and viewable by the players and may provide the ability for player's to post comments. In such embodiments, a player's turn may include marketing 1232 the product associated with a user on the message board to earn points, posting messages 1234 regarding transactions (swaps or steals) that took place during the player's turn, and post 1236 responses to other messages. Messages 1234 regarding transactions (swaps or steals) may include automatically generate text that the player may edit or not and then post to the message board or transmit to the other part of the transaction. Marketing messages may result in points being associated with the user for use at different points in the game.

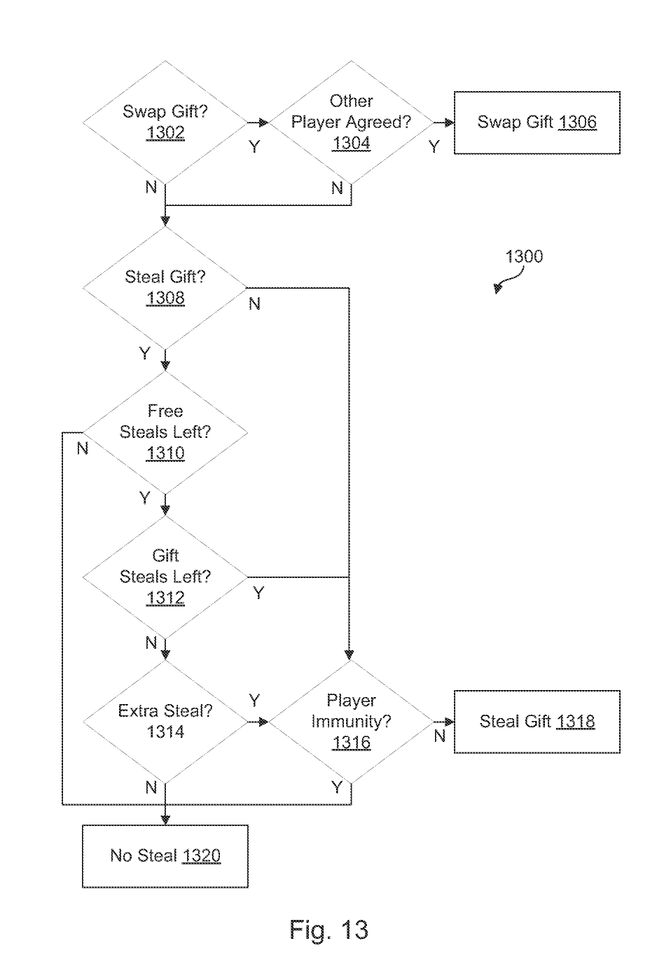

FIG. 13 illustrates a method 1300 for controlling the exchange of gifts between players. The method 1300 may include evaluating whether a player chooses 1302 to swap gifts with a second player and evaluating 1304 whether the second player agrees to the swap. If the player chooses to swap and the second player agrees, then the exchange of gifts is performed by swapping the identifiers of the products associated with the swapping players.

The player may also indicate a choice 1308 to steal a product from a second player. If so, then the method 1300 may include evaluating 1310 whether the player has any steals left. Upon the commencement of the game a player may be given a certain number of steals that are used up with each steal. In some embodiments, additional steals may be purchased using points acquired by purchase or during game play. In some embodiments, a steal may be purchased outright. If the player is found 1310 to have free steals, the method 1300 may include evaluating 1312 whether the gift the player wishes to steal has remaining steals. Each gift may have a number of permitted steals associated therewith such that it can only be stolen a certain number of times before it can no longer be stolen. If the gift is found 1312 to not have any more steals, the method 1300 may include evaluating whether the stealing player has an extra steal. An extra steal may be purchased with points or money and allows a player to steal a gift notwithstanding the fact that the gift has no more steals left.

If the player chooses to steal the gift, has free steals left, and the player has an extra steal or the gift has steals left, the method 1300 may include evaluating 1316 whether the second player has and chooses to use immunity from stealing. An immunity may be purchased with points or money and is used up by choosing to invoke the immunity in response to an attempt to steal. In some embodiments, once the immunity is used it cannot be used again and another immunity must be purchased if one is to be used.

If the player cannot or chooses not to use immunity, then the gift of the second player is stolen 1318. This may include swapping the product identifiers of the products associated with the stealing player and the second player. If the player uses immunity or the steal is otherwise not permitted according to other method steps, then the steal is refused 1320.

FIG. 14 illustrates a method 1400 for providing a hold to a player. A player may not be able to participate at the commencement of a game or may otherwise wish to prevent others from selecting a product selected by that player. Accordingly in some embodiments a user may purchase 1402 a hold prior to the start of a game. The hold may be purchased with points or money. The game may then commence 1404 as described hereinabove, for example player turns may commence according to the method 1100. The product associated with the player will then be unavailable for choosing from the gift pile by any of the other users until the hold is released. The hold is released 1406 if the held product is found 1408 to have been selected from the gift pile by the player who purchased the hold, the held product is found 1410 to be the last gift in the pile, or half the game is found 1412 to have passed. Half the game may be found 1412 if half the players have already taken their turn or half of a defined play time period has elapsed.

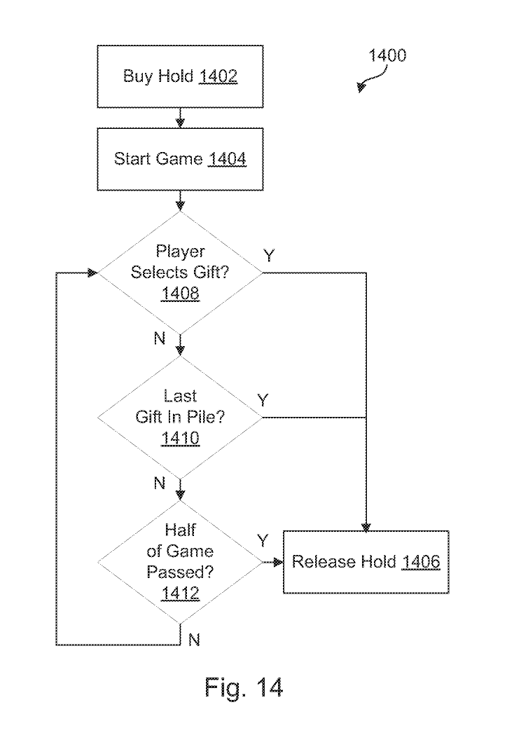

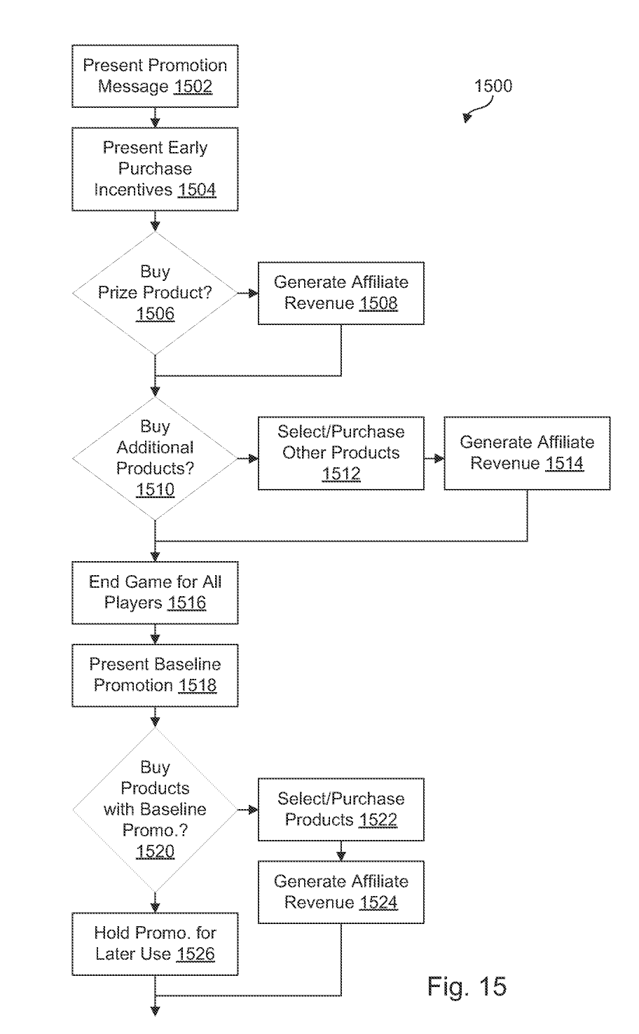

FIG. 15 illustrates a method 1500 for presenting a prize product and a promotion, such as discount amount, according to an outcome of a product-based game, such as the white elephant type game described hereinabove. The method 1500 may include presenting 1502 a promotion message including a promotion description, such as a discount amount, and a prize product determined according to an outcome of the game as described herienbelow. The method 1500 may also include presenting 1504 early purchase incentives. The early purchase incentives may include an additional discount, an additional free product given if the promotion is redeemed or other incentive given to a player if the promotion is redeemed by a certain time. The player may then choose 1506 to buy the prize product. If so, then affiliate revenue may be generated 1508 for an entity owning or controlling the host server 202. The affiliate revenue may be a commission for the purchase of the prize product. The user may also be presented with a choice 1510 to buy additional products. If so, then the selection and purchase of the products may be completed 1512 and additional affiliate revenue may be generated 1514 for the entity owning or controlling the host server 202.

As noted above, in some embodiments, a player may choose to end the game early, which may include payment of an early fee. In such embodiments, the game may end 1516 after a user has an opportunity to see the promotion message and redeem the promotion. However, even where an early end has been chosen, the end of the game for other players may precede or follow redemption of a discount by a player. Upon ending 1516 of the game for all players, all players may be presented 1518 with a baseline discount or baseline promotion, such as a baseline discount, that is independent of the outcome of the game and offers all players an opportunity to purchase products with the baseline promotion. As in other embodiments, the baseline promotion may be in the form of a promotional code or other data structure enabling a user to purchase a product at a discount. The player may then choose 1520 whether to buy products using the baseline promotion. If so, then the player may complete 1522 selection and purchase of the products benefiting from the baseline promotion, which may include generating 1524 affiliate revenue for an entity owning or controlling the host server 202. If a player chooses 1520 not to purchase products using the baseline promotion, then the player may hold 1526 the baseline promotion for later use.

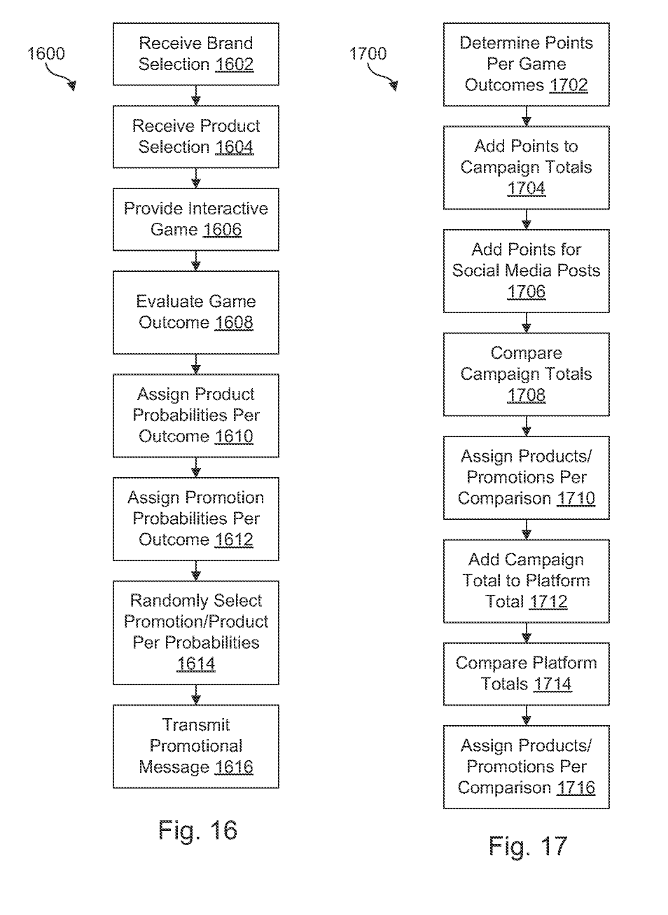

FIG. 16 illustrates an alternative method for conducting a product-based game. The method 1600 may include receiving 1602 a brand selection. Brand selection may include the selection of manufacturer brand or a retailer brand. The player's product selection may also be received 1604. Receiving a player's product selection may also include receiving a player's ranking of the selected products. Where a brand selection has been received 1602, then the product selection may be limited to those associated with the selected brand, e.g., made by the brand manufacturer, products offered by the brand retailer, or products part of a sponsored advertising campaign. In some embodiment, receiving 1602 the brand selection may automatically result in selection of a set of products such that receiving 1604 a player selection is omitted. Receiving 1602 a brand selection and/or receiving 1604 a product selection may be performed on the user workstation 212 or on the host server 202.

The method 1600 may then include providing 1606 an interactive game to a user. The game interface for providing 1606 the interactive game may be displayed on the player workstation 212. Functions for updating the game interface and updating the game state in response to user inputs may be executed on one or both of the user workstation 212 and host server 202.

The outcome of the game may then be evaluated 1608. Evaluating 1608 may include evaluating a point total, success of failure at completing a task, or some other metric. A probability of obtaining a particular product may be assigned 1610 according to the evaluation 1608 of the outcome. In some embodiments, probabilities may be assigned 1610 to each, or each of a subset, of the products identified in the product selection received 1604. An additional probability may be generated according to the outcome indicating the likelihood of the user not receiving a promotion for any product. The method 1600 may also include assigning 1612 one or more probabilities to one or more promotion types or amounts. For example, probabilities of obtaining X, Y, and Z % discounts may be determined, where X, Y, and Z are values between 100 and 0. In some embodiments, promotion types may include promotions other than discount percentages such as “buy one get one free” offers, a free gift with purchase, access to exclusive online content, or other promotions described herein or as known in the art. In some embodiments, larger discount amounts or more valuable promotions may be assigned a larger probability for a larger point total or a successful completion of a task. In some embodiments, the sum of the probabilities for each possible promotion is equal to 1, or, stated differently, the probability of obtaining at least one promotion is 100%. A product and promotion may be randomly or pseudo-randomly selected 1614 according to the probabilities assigned at steps 1610, 1612. The steps of assigning 1610, 1612 probabilities and selecting 1614 a product and promotion may be performed on one or both of a player workstation 212 or on the host server 202. A promotional message indicating the selected product and promotion may then be transmitted 1616 to the player workstation 212 and/or displayed on the player workstation 212. The method of FIG. 16 may be combined with any of the foregoing methods. In particular, any of the games or methods for initiating games described herein may be used with the method 1600.

In some embodiments, a player may be limited to one promotion per product within a given time period, e.g., per day, week, month, season, and the like. In such embodiments, if a product is randomly selected for which a promotion has already been awarded to a player within the given time period, another product may be selected or only a specified number of points may be assigned to a player's point total for future use, such as for promotions assigned using the method of FIG. 17 described hereinbelow. In some embodiments, the method includes alerting a player that the player is not eligible to obtain another discount for a product if the player attempts to play for a discount to product. In some embodiments, a player is not eligible to win a promotion for a product is an unexpired and unredeemed promotion for the same product has already been assigned to the player, but may be eligible following expiration or redemption of the promotion.

Tables 1 and 2 illustrate examples of how probabilities of obtaining a product may be assigned 1610 and probabilities of obtaining a promotion may be assigned 1612. The steps of assigning 1610, 1612 probabilities may be performed by looking up probabilities from tables, such as Tables 1 and 2.

TABLE 1
Product Probabilities

| | Only | ⅙ of | | | | | | | |
|---|---|---|---|---|---|---|---|---|---|
| | Points | Items | Item 1 | Item 2 | Item 3 | Item 4 | Item 5 | Item 6 | Total |
| Points | % | % | % | % | % | % | % | % | % |
| 1,000- | 25 | 75 | 10.67 | 10.00 | 9.41 | 8.89 | 6.67 | 5.33 | 100 |
| 9,999 | | | | | | | | | |
| 10,000- | 20 | 80 | 8.00 | 8.22 | 8.22 | 8.45 | 6.98 | 5.88 | 100 |
| 39,999 | | | | | | | | | |
| 40,000- | 15 | 85 | 6.27 | 6.89 | 7.24 | 8.07 | 7.43 | 6.72 | 100 |
| 59,999 | | | | | | | | | |
| 60,000- | 10 | 90 | 5.08 | 5.86 | 6.43 | 7.73 | 8.08 | 8.08 | 100 |
| 79,999 | | | | | | | | | |
| 80,000- | 5 | 95 | 4.21 | 5.05 | 5.74 | 7.43 | 9.02 | 10.53 | 100 |
| 150,000 | | | | | | | | | |

TABLE 2
Promotion Probabilities

| | 15% | 20% | 25% | 30% | 35% | 40% | Total |
|---|---|---|---|---|---|---|---|
| Points | off % | off % | off % | off % | off % | off % | % |
| 1,000- | 27 | 25 | 18 | 15 | 10 | 5 | 100 |
| 9,999 | | | | | | | |
| 10,000- | 21.5 | 21.25 | 17.25 | 15.75 | 13.75 | 10.5 | 100 |
| 39,999 | | | | | | | |
| 40,000- | 16 | 17.5 | 16.5 | 16.5 | 17.5 | 16 | 100 |
| 59,999 | | | | | | | |
| 60,000- | 10.5 | 13.75 | 15.75 | 17.25 | 21.25 | 21.25 | 100 |
| 79,999 | | | | | | | |
| 80,000- | 5 | 10 | 15 | 18 | 25 | 27 | 100 |
| 150,000 | | | | | | | |

FIG. 17 illustrates a method for assigning products and promotions according to a game outcome for a player. The playing of games and accumulation of points during a game may be as described in any of the methods described herein. The method 1700 may include determining 1702 a number of points according to a game, with the game being played and points accumulated according to any of the methods described herein. In certain embodiments, games are provided in the context of an advertising campaign. The campaign may be in the context of a specific manufacturer or retailer brand. Accordingly, a brand selection (such as described as part of the method 1600) may invoke a game associated with an advertising campaign for that selected brand. In such embodiments, a player's point total from a game played in the context of an advertising campaign may be added 1704 to a campaign total for the player.

Points may also be added 1706 to the campaign total for postings messages regarding one or more of the game, branded products, and the brand associated with the advertising campaign. The postings may be made to a player's social media account through an interface provided by the host server 202 or on the player workstation 212 such that a provider of the advertising campaign can verify the content and actual posting of the player's comments. Alternatively, the fact of a player's social media postings may be verified after the fact by accessing the player's social media site and analyzing the content thereof.

Additional points may be awarded for a “paired game.” A paired game is a game in which two players agree to play the same game. Upon both players completing the game, both players are awarded additional points. Paired games encourage people to recruit other players. Paired games may be set up using social media sites as discussed herein. Actual interaction between the players during a paired game is not required. In some embodiments, additional point for paired games will not be awarded more than once to the same pair of players within a given period, such as 24 hours. However, an individual player may have paired games with multiple other players and still receive the additional points for paired games.

In some embodiments, a player may be limited on the number of games that may be played per day for points to be added to the campaign total. In still other embodiments, the number of individual games is limited, but the number of paired games is not, or has a separate limit, provided a player is paired with a different player for each paired game.

The campaign totals for a plurality of players may be compared 1708 to one another and products and corresponding promotions may be assigned 1710 to one or more of the players according to the comparison. In some embodiments, the promotions assigned based on campaign totals are for items of greater value and greater appeal and the discounts offered may be even larger (such as up to 99% off). Assigning 1710 a product and promotion may include assigning a probability of obtaining a promotion for a coveted product according to a rank of a player's campaign point total and then randomly or pseudo randomly assigning a product and/or promotion according to that probability. In alternative embodiments, the probability of a promotion for a product and the probability of obtaining a particular promotion are assigned to each player independently according to campaign point totals as described with respect to the method 1600 of FIG. 16. Assigning 1710 of products and/or promotions may occur periodically during an advertising campaign, at the end of an advertising campaign, or at some other interval in a fixed or open time period. In some embodiments, a promotion for a product may be assigned or not assigned upon a player achieving one or more campaign total thresholds according to some predetermined probability.

In some embodiments, a player's campaign totals and/or individual game totals may be added 1712 to a platform total for that player. The platform total may reflect all points accumulated from playing games provided by a certain provider. The platform total may indicate total points with respect to individual games and/or a lumped sum of all points. The player's platform total 1712 may be compared 1714 to platform totals for other players, either with respect to individual games or a lump sum of points accumulated for all games. A product and promotion may then be assigned 1716 according to the comparison. Assigning 1716 a product and promotion may include assigning a probability of obtaining a promotion for a coveted product according to a rank of a player's platform total and then randomly assigning or not assigning the promotion for the product according to the probability. Alternatively, the type of promotion and the product associated with a promotion may be independently assigned based on a player's platform total, such as using the method 1600 of FIG. 16. Assigning 1716 of products and/or promotions may occur periodically during the operation of a game platform. In some embodiments, a promotion for a product may be assigned 1716 or not assigned upon a player achieving one or more platform total thresholds according to some predetermined probability.

Any number of games may advantageously be provided using the methods and systems described herein. Various examples of such games are described herein. As noted previously, the games may advantageously use images for products that can be awarded as part of a promotion as interactive game interface elements.

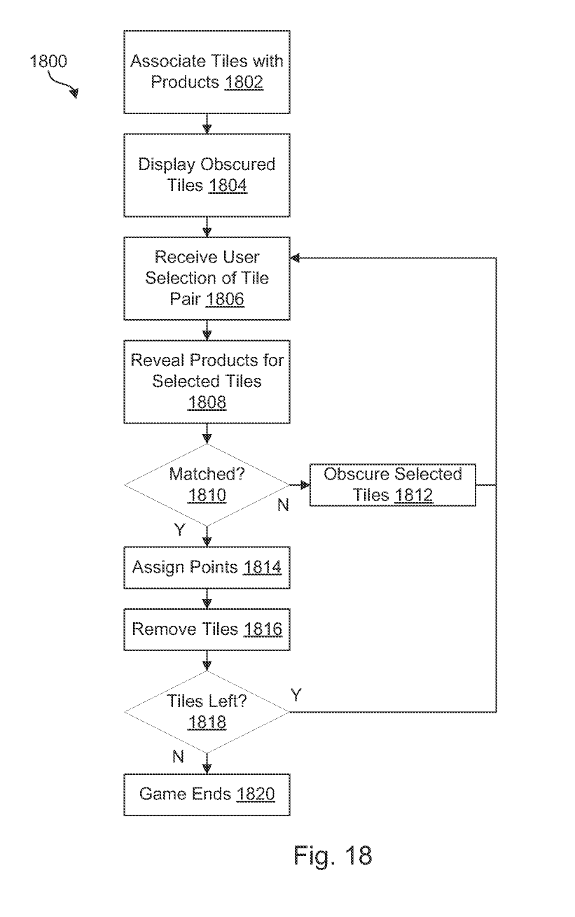

FIG. 18 illustrates a method 1800 for providing a “memory” game. Pairs of tiles are each associated 1802 with a product, such as products selected by a player in the methods described hereinabove. The tiles are then displayed 1804 in a random array without displaying images of the products associated therewith. A player's selection of a pair of the obscured tiles may then be received 1806. The products associated with the selected tiles are briefly revealed 1808 to the player and evaluated 1810 to determine if they match. If not, the product images for the selected tiles are again obscured 1812. If the selected tiles are found 1810 to match, then points are assigned 1814 and the selected tiles are removed 1816. If no tiles are found 1818 to be left, the game ends 1820, otherwise, another pair of selected tiles are received 1806 and the method proceeds as described. In some embodiments, the game may end upon expiration of a time limit. The points assigned may depend on the time spent in identifying all matches. The method 1800 may include multiple rounds with the number of tiles being incremented for some or all rounds. The method 1800 may be executed on one of the player workstation 212 and server 202, or may be distributed across both of these devices. The display of the tiles and player interaction with the game interface may be performed on the workstation 212.

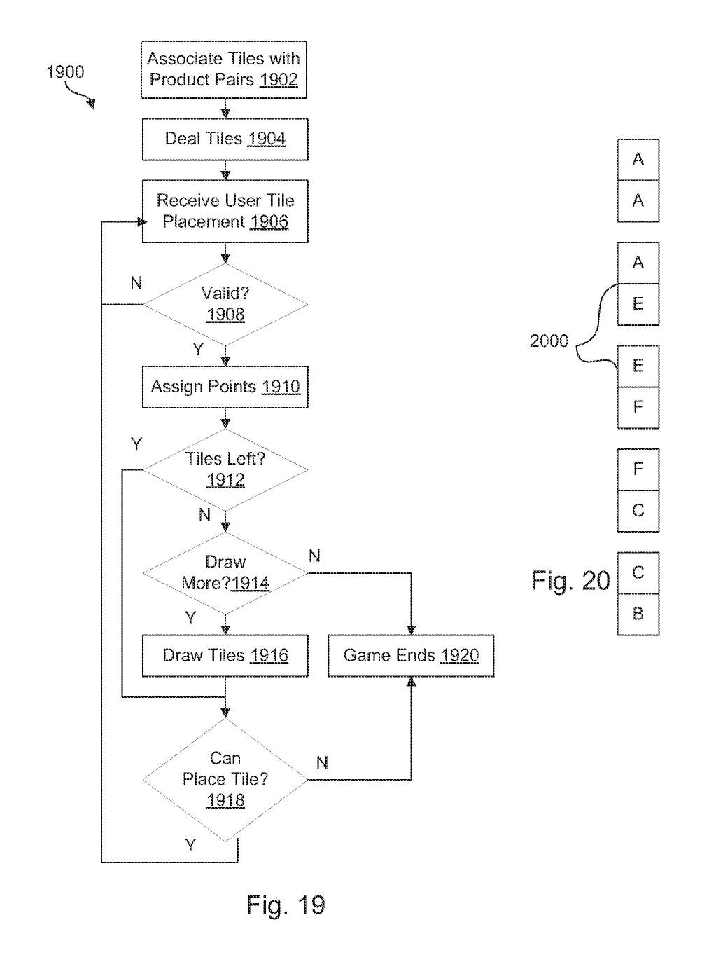

FIG. 19 illustrates a method 1900 for performing a dominos type game, such as a “train” or “Mexican train” type game. The method 1900 may be executed on one or both of a player workstation 212 or on the host server 202. The method 1900 may include generating tiles by associating 1902 each tile with a pair of products, the products may be products selected by a player according to methods described hereinabove or products selected automatically according to a player's brand selection. The products associated with an individual tile may be identical or different.

The tiles may then be dealt 1904. This may include associating the tiles with a player. Dealing 1904 the tiles may include revealing to the player the products associated with each tile by displaying the images of the two products associated with each tile thereon. Displaying the tiles enables the player to devise a strategy to create the longest train possible. Referring to FIG. 20, a train may be generated by placing the tiles 2000 end to end such that each product of each tile matches the immediately adjacent product of an adjacent tile. The first tile in the train may be constrained to be a double tile such that both products associated therewith are identical.

The method 1900 may include receiving 1906 a player's proposed tile placement and evaluating 1908 if the placement is valid. If not, the placement is not performed. If it is valid, then the placement is performed and points are assigned 1910. The method 1900 may include evaluating 1912 whether the player has tiles left. If not, the player may have the option of drawing more tiles. If the player chooses 1914 to draw more, more tiles are dealt 1916 to the player. If the player chooses 1914 not to draw tiles, then the game ends 1920.

If a player has tiles at the end of a turn, the method 1900 may include evaluating 1918 at the end of a turn whether a player can make any more valid placements. If not, then the game ends 1920. Ending the game may include calculating a final tally of points, which may include assigning a point value to all tiles placed and subtracting the point value of unplaced tiles. Points may also be assigned according to the time spent in placing tiles. In some embodiments, the game ends upon expiration of a time period.

The rules for what constitutes a valid tile placement may vary depending on the type of play. The method 1900 may be executed in the context of a multiplayer game. The players may be assembled using methods described herein such as using a social media site.

In one example, the game implemented is based loosely on the original game of Mexican Train Dominoes with some modifications. Possible game scenarios include:
1. Single Player, simultaneous versus Self (more like Solitaire)
2. Single Player, sequential, versus System (more like online version of Mexican Train game)
3. Multi-Player, Simultaneous (in real time) and Sequentially
4. Multi-Player, Asynchronously (over the course of time when Players check in) and Sequentially

For Single-Player game, a player plays as many of the player's dominoes as possible in a continuous train within the specified amount of time to get the highest total score after deducting points from dominoes that are not played. For Multi-Player games, the object is to be the first to play all of one's dominoes, or at least as many high-point dominoes as possible, in each round. The highest total score at the end of all rounds wins the game.

Single Player, Simultaneous v. Self

As noted above a retailer or brand may provide a collection of sponsored items for an advertising campaign, e.g., a period of time during which a retailer or brand features a collection of products paired with promotions and deployed on a web, mobile, advertising or social media platform.

In one embodiment, the game logic creates 51 tiles, each of which feature two images from the sponsored products, or products selected by a player. This creates the foundation for a double nine draw dominoes style game. A player selects up to nine products which become the images on the domino tiles.

Fifteen tiles are dealt to an individual player in a single player game. Multi-player games require alternative distribution of tiles based on total number of players as known in the art of domino-type games. A player organizes tiles and strategizes how the player will earn the highest number of points by placing them next to each other in a continuous train such that two matched images are always adjacent to each other from two different tiles. Each of the two images on each tile has a points value associated it with it that is visible on the tile to the player.

Once the tiles are dealt, the player begins placing tiles in the player's train with a clock measuring the time spent. The player selects a tile to start the train and continues placing tiles on one end of the train. Once a tile is placed down, it is a confirmed placement. Time elapsed and total points may be displayed for the player. In some embodiments, tile values are displayed on the tiles and based on the player's ranking of the products associated with the tiles, such as in reverse order, e.g., #1 rank is #9 in points value. In some embodiments, double clicking reverses the direction of a tile (i.e. the right side image becomes the left side image and vice versa). As they are used, the tiles are removed from the player's tile pile and cannot to be reused.

If a player does not have a tile that can be played, the player may pick a tile or end the game. If the player picks a tile that can be added to the train, the player continues to play until the player can no longer add tiles to the player's train. At this point, the game ends. The player may or may not have tiles remaining. The player may pick an additional X number of tiles.

The game ends at the earlier of the player using all the player's tiles in the player's tile pile or the player running out of additional tiles to play after adding tiles (if the player chooses to do so). A player may also manually end the game if the player believes the optimized score has been obtained. A player's score is the aggregate of all the points on the tiles in the player's train minus the value of the points on the tiles in the player's tile pile.

Upon concluding the game, a player sees the total points earned and receives a promotion based on the outcome of the game. This may include calculations unique to the provider of the game interface or to the brand manufacturer or retailer providing the game. Selection of a prize product and a promotion may be according to any of the methods described herein.

In some embodiments, the game implemented using the system and interfaces described herein may include the Mexican Train game described in the original “official” rules by Roy & Katie Parsons© 1994 and copyrighted by Puremco, Inc. in 2005, which are hereby incorporated herein by reference in their entirety as written by David Bauguess in 2007 for ease of use.

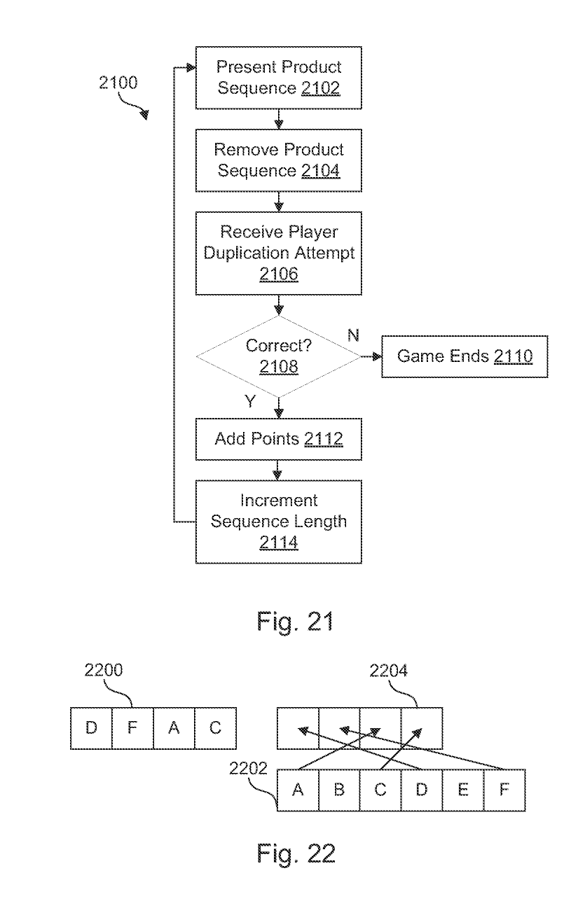

FIG. 21 illustrates a method 2100 for performing a “sequence” type game. As noted hereinabove with respect to other games and methods, the method 2100 may be preceded by the player selecting a number of products or selecting a brand with a number of products associated therewith. The game described with respect to the method 2100 may be provided as a game in the context of any of the methods described herein. The steps of the method 2100 may be performed on one or both of a player workstation 212 and the host server 202.

The method 2100 includes presenting 2102 a product sequence including images of certain products in a particular order. The sequence is then removed 2104 and player duplication attempt is received 2106. The player may have available an array of product images displayed to choose from when attempting to duplicate the sequence. The duplication attempt may be received 2106 by receiving player clicks on displayed product images. As shown in FIG. 22, a player may be presented with a sequence 2200. The player may then be presented with an array 2202 of choices that may be selected to populate the player's duplication attempt 2204.

If the player's duplication attempt is not found 2108 to be correct than the game ends 2110. If the duplication attempt is found 2108 to be correct then points are added 2112 to the player's score and the length of the sequence presented is incremented 2114, the method then returns to presenting 2102 of a random sequence having the incremented length. The player may be assigned a product and promotion according to any of the methods described herein, such as the methods of FIG. 16 and/or FIG. 17.

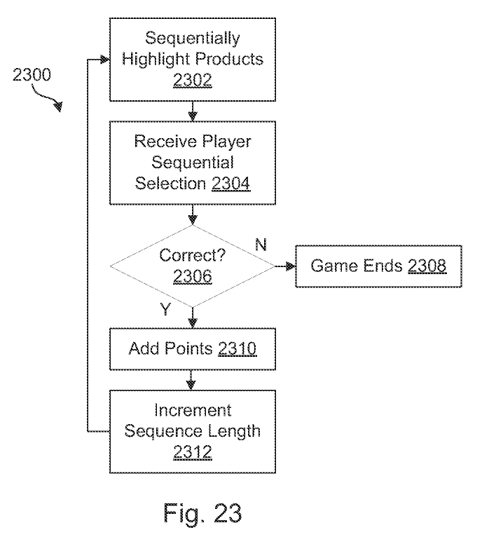

FIG. 23 illustrates a method 2100 for performing another “sequence” type game. As noted hereinabove with respect to other games and methods, the method 2300 may be preceded by the player selecting a number of products or selecting a brand with a number of products associated therewith. The game described with respect to the method 2300 may be provided as a game in the context of any of the methods described herein. The steps of the method 2300 may be performed on one or both of a player workstation 212 and the host server 202.

The method 2300 may include sequentially highlighting 2302 product images. The products displayed may be selected by a player or selected according to a player's brand selection. Sequential highlighting may include briefly displaying a border around an image or otherwise visibly altering the product image itself or the area around the product image. The method 2300 then includes receiving 2304 a player's attempt to duplicate the sequence. This may include receiving a player's sequential selection of the product images, such as by clicking on them. If the player's sequential selection is not found 2308 to be correct, then the game ends 2308. Otherwise, points are added 2310 to a player's score and the length of the sequence is incremented 2312 and another sequence having the incremented length is presented 2302. The player may be assigned a product and promotion according to any of the methods described herein, such as the methods of FIG. 16 and/or 17.

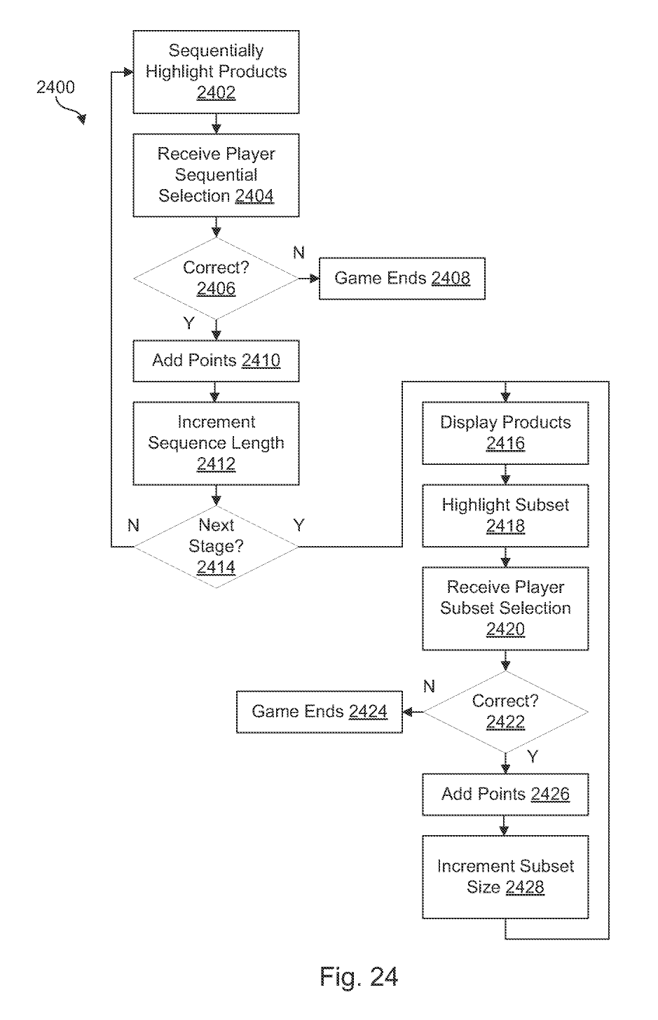

FIG. 24 illustrates a method 2400 for performing another “sequence” type game. As noted hereinabove with respect to other games and methods, the method 2400 may be preceded by the player selecting a number of products or selecting a brand with a number of products associated therewith. The game described with respect to the method 2400 may be provided as a game in the context of any of the methods described herein. The steps of the method 2400 may be performed on one or both of a player workstation 212 and the host server 202.

The method 2400 may include sequentially highlighting 2402 product images. The products displayed may be selected by a player or selected according to a player's brand selection. Sequential highlighting may include briefly displaying a border around an image or otherwise visibly altering the product image itself or the area around the product image. The method 2400 then includes receiving 2404 a player's attempt to duplicate the sequence. This may include receiving a player's sequential selection of the product images, such as by clicking on them. If the player's sequential selection is not found 2406 to be correct, then the game ends 2408. Otherwise, points are added 2410 to a player's score and the length of the sequence is incremented 2412.

The method 2400 may include evaluating 2414 whether the sequence length is long enough to advance to a next stage.

If not, then another sequence is highlighted 2402 and the method continues. If so, then a product array is displayed 2416. A subset of these products is then simultaneously highlighted 2418 briefly. The player's attempt to duplicate the subset selection is then received 2420. This may include a player clicking on product images within the displayed product. If the player's subset selection is not found 2422 to match that displayed at step 2416, then the game ends 2424. The player may be assigned and a product and promotion according to any of the methods described herein, such as the methods of FIG. 16 and/or 17. If the player duplicates the subset, points are added 2426 to the player's score and the subset size is incremented 2428. The products from which the subset is selected may also be incremented. The product images may again be presented 2416 and a subset highlighted 2418 and so on.

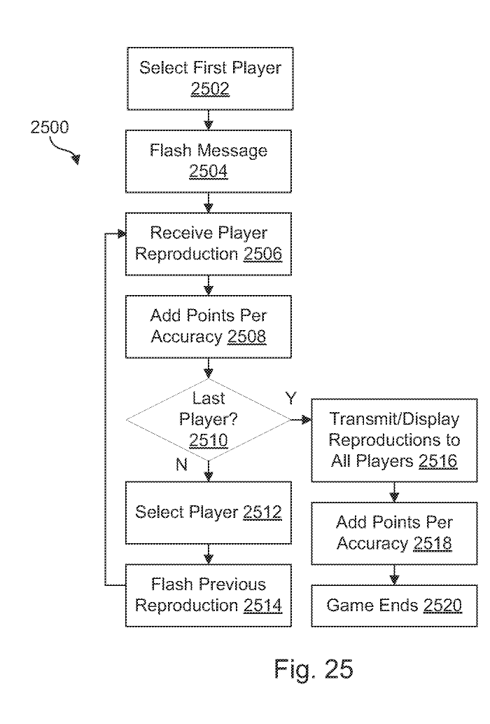

FIG. 25 illustrates a method 2500 for performing a “telephone” type game. As noted hereinabove with respect to other games and methods, the method 2500 may be preceded by the player selecting a number of products or selecting a brand with a number of products associated therewith. The game described with respect to the method 2500 may be provided as a game in the context of any of the methods described herein. The steps of the method 2500 may be performed on one or both of a player workstation 212 and the host server 202. The method 2500 is performed with multiple players. The players may be assembled and launch a common game according to methods described herein, which may include the use of social media sites as described herein.

The method 2500 may include selecting 2502 a first player. A brief message, such as a text message or audio message, is briefly presented 2504 to the first player. The player then attempts to reproduce the message by typing it or verbally repeating it into a microphone. The player reproduction is then received 2506. Points are added 2508 to the player's score according to the accuracy of the reproduction, with greater points added 2508 for greater accuracy. If more players are found 2510 to exist that have not taken a turn, another player is selected 2512 and the reproduction received 2506 from the previous player is briefly presented 2514. The reproduction of that player is then received 2506 and the method continues.

If the last player 2510 is found to have taken a turn, then the method 2500 may include transmitting and/or displaying 2516 the original message and the reproductions of all the players to all of the players. Points may be added 2518 to all players' scores according to the accuracy of the final reproduction relative to the original message presented at step 2504 and the game ends 2520. The players may then be assigned a promotion for a product from products selected by the players or according to a brand selection according to any of the methods described herein.

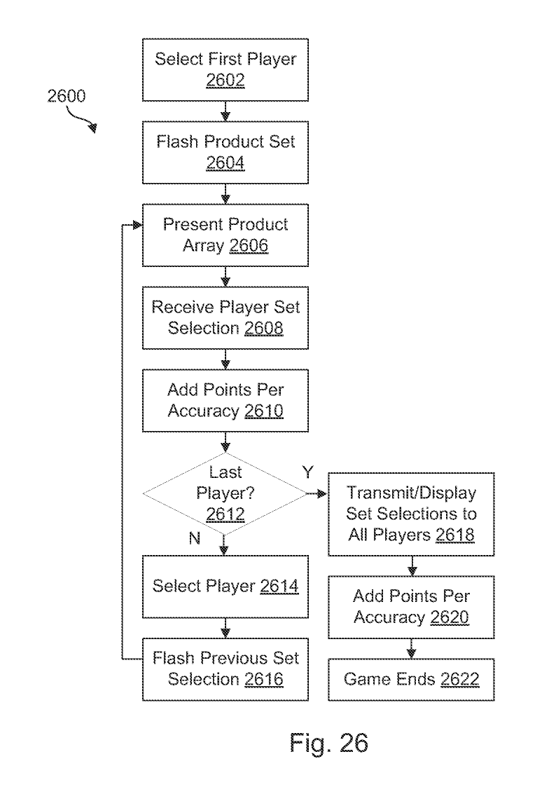

FIG. 26 illustrates a method 2600 for performing an alternative “telephone” type game. As noted hereinabove with respect to other games and methods, the method 2600 may be preceded by the player selecting a number of products or selecting a brand with a number of products associated therewith. The game described with respect to the method 2600 may be provided as a game in the context of any of the methods described herein. The steps of the method 2600 may be performed on one or both of a player workstation 212 and the host server 202. The method 2600 may be performed with multiple players. The players may be assembled and launch a common game according to methods described herein, which may include the use of social media sites as described herein.

The method 2600 may include selecting 2602 a first player from among the players who will be participating and briefly presenting 2604 a product set from the products selected by the players or selected according to a brand selection. The player may then be presented 2606 with a product selection that includes more products than those presented 2604. A player set selection is then received 2608 that represents the player's attempt to reproduce the product set presented 2604. This may include receiving clicks on product images representing the product selection. Points are then added 2610 to the player's score according to the accuracy of the player's reproduction, with more accurate reproductions receiving greater points. If the player is not found 2612 to be the last player, then another player is selected 2614 and the set selection of the previous player is briefly presented 2616. The method then repeats starting at step 2506 with respect to the player selected at step 2614.

If the last player is found 2612 to have taken a turn, then the original product set and the set selections of all the players may be transmitted and/or displayed 2618 to all the players. Points may be added 2620 to all the player's scores according to an accuracy of the final set selection with respect to the original selection. The game may then end 2622. Promotions or products may be assigned to the players according to the outcome of the game according to the methods described herein.

In some embodiments, the number of players may be open and turns may be conducted by a player forwarding an invitation to another player to take a turn. In such embodiments, the last player is the person who decides not to continue playing the game by forwarding an invitation to take a turn to someone else. The last player may be the last player to take a turn before an invitee fails to respond within a proscribed time period.

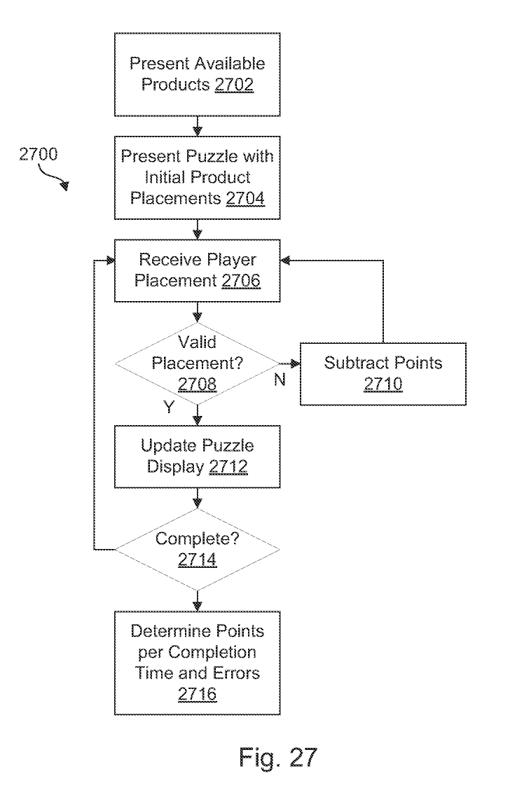

FIG. 27 illustrates a method 2700 for performing a puzzle game, such as Sudoku game. As noted hereinabove with respect to other games and methods, the method 2700 may be preceded by the player selecting a number of products or selecting a brand with a number of products associated therewith. The game described with respect to the method 2700 may be provided as a game in the context of any of the methods described herein. The steps of the method 2700 may be performed on one or both of a player workstation 212 and the host server 202.

The method 2700 may include presenting 2702 the products, e.g., images of products, that are available to solve the puzzle and presenting 2704 the puzzle with initial product placements. For a Sudoku game, the puzzle is an N×N grid and the object is to populate the grid according to placement rules as known in the art of Sudoku puzzles, with the exception that numbers are replaced with product images. As an example, in a typical Sudoku puzzle, a number may not be placed in a column or row that has that same number in it. In the illustrated embodiment, a product image may not occupy a row or column that also has that same product image in it. Other analogs to typical Sudoku rules are also contemplated wherein a rules applied to numbers are applied to product images.

The puzzle is solved by receiving 2706 a player placement and evaluating 2708 the validity of the placement. If the placement is invalid, points may be subtracted 2710 from the player's score. If it is valid, then the puzzle is updated 2712 to include the placed product image. If the puzzle is not found 2714 to be complete, then another product placement is received 2706 and the method proceeds. If the puzzle is found 2714 to be complete, then the number of points may be determined 2716 according to the time taken to complete the puzzle and the number of invalid placement attempts.

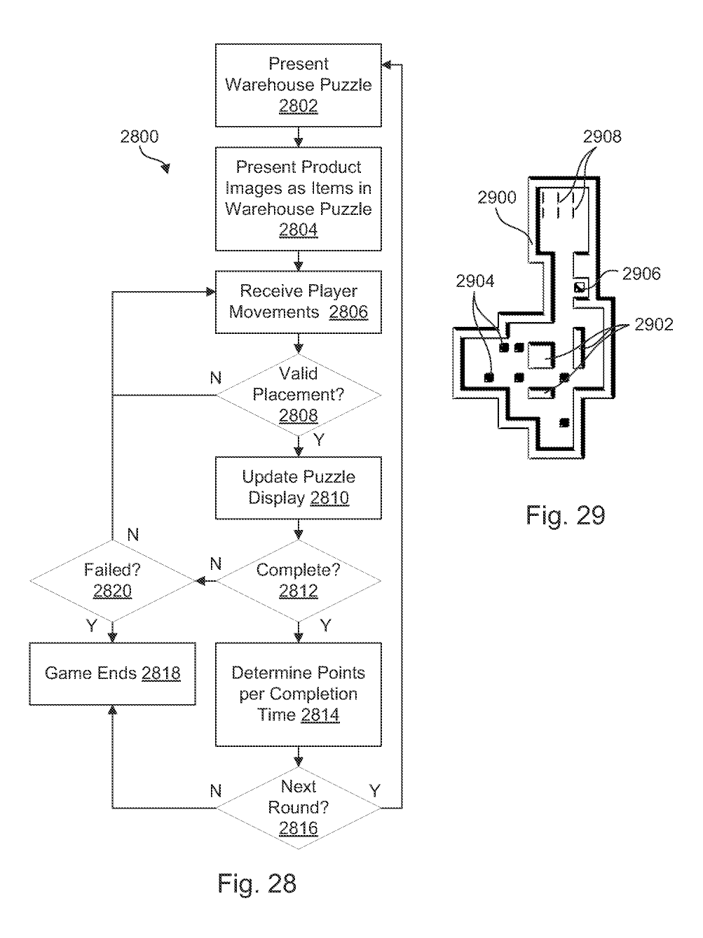

FIG. 28 illustrates a method 2800 for performing a warehouse or “Sokoban” type game. As noted hereinabove with respect to other games and methods, the method 2800 may be preceded by the player selecting a number of products or selecting a brand with a number of products associated therewith. The game described with respect to the method 2800 may be provided as a game in the context of any of the methods described herein. The steps of the method 2800 may be performed on one or both of a player workstation 212 and the host server 202.

As known in the art, a Sokoban type game includes a floor plan of a warehouse with various obstacles and objects. The objects must be moved around using only pushing movements to a goal configuration by a character that is constrained to move within the floor plan and cannot pass through or over objects or obstacles. In the illustrated embodiment, the objects to be moved around are represented using images of selected products.

FIG. 29 illustrates an example of a puzzle layout, including a floor plan 2900, obstacles 2902, objects 2904 for moving, and a character 2906 that can be moved in response to player inputs. The objects 2904 may be represented using product images. The floor plan 2900 may include markers 2908 indicating the location to which the objects 2904 are to be moved to complete the puzzle.

The method 2800 may therefore include presenting 2802 a warehouse puzzle and presenting 2804 product images as items to be moved around within the puzzle. Player movements of the character are received 2806. If the movement is found 2808 to be valid the character and any objects moved by the character are moved and the puzzle display is updated 2810. Otherwise, the movement is not performed and the next movement is received 2806. If the puzzle is found 2812 to be complete than the points assigned to the player are determined 2814 according to a time required to complete the puzzle. The amount of points may also be greater for more difficult puzzles. If the player decides 2816 to play another round then the method repeats at step 2802 with a new puzzle. Otherwise, the game ends 2818.

If the puzzle is not found 2812 to be complete and there is still a possible solution such that the player is not found 2820 to have failed, then the next player move is received 2806 and the method repeats. If the player is found 2820 to have failed the game ends 2818. The player may be assigned a promotion for a product according to the methods described herein according to points awarded and/or success in completing one or more puzzles.

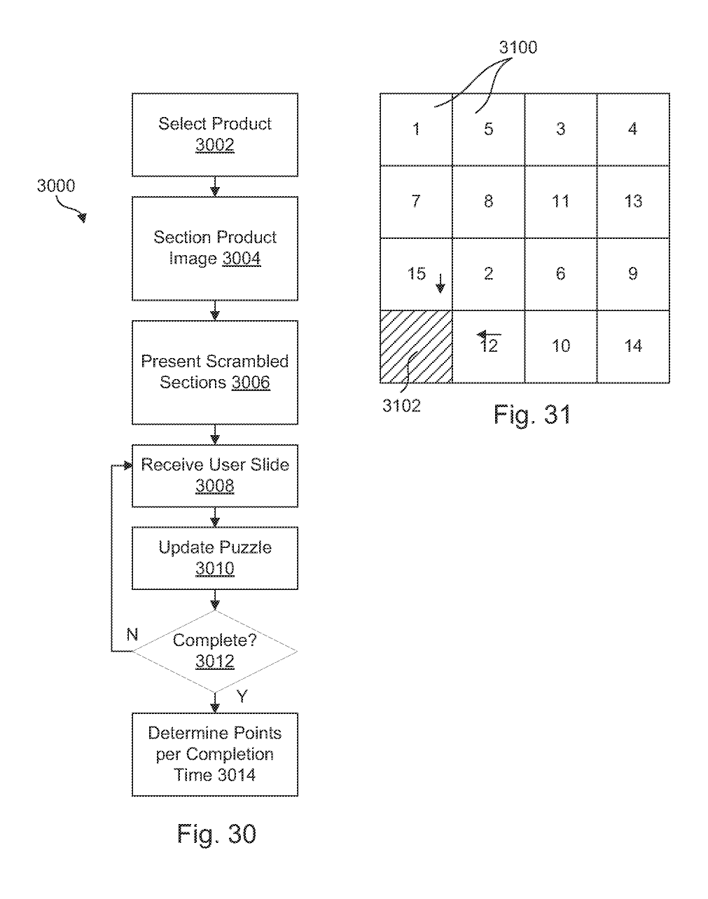

FIG. 30 illustrates a method 3000 for performing a “slide” type game. As noted hereinabove with respect to other games and methods, the method 3000 may be preceded by the player selecting a number of products or selecting a brand with a number of products associated therewith. The game described with respect to the method 3000 may be provided as a game in the context of any of the methods described herein. The steps of the method 3000 may be performed on one or both of a player workstation 212 and the host server 202.

The method 3000 includes selecting 3002 a product, either by a player or automatically based on the player selected products or selected brand. A product image representing the selected product is sectioned 3004 into equally sized rectangles and the sections are presented 3006 in a scrambled configuration such that they do not form the original image.

FIG. 31 illustrates an unsolved slide puzzle. The number on the tiles 3100 represent the correct ordering of the tiles. The shaded space 3102 represents an empty spot into which an adjacent tile may be slid.

The method 3000 may include receiving 3008 a player slide movement and updating 3010 the puzzle to reflect the movement. If the puzzle is found 3012 to be complete, then points are determined 3014 according to the time required to complete the puzzle. Otherwise, the next movement is received 3008 and the game continues. Upon completion of the game a promotion for the product selected 3002 or some other product may be assigned according to the methods described herein.

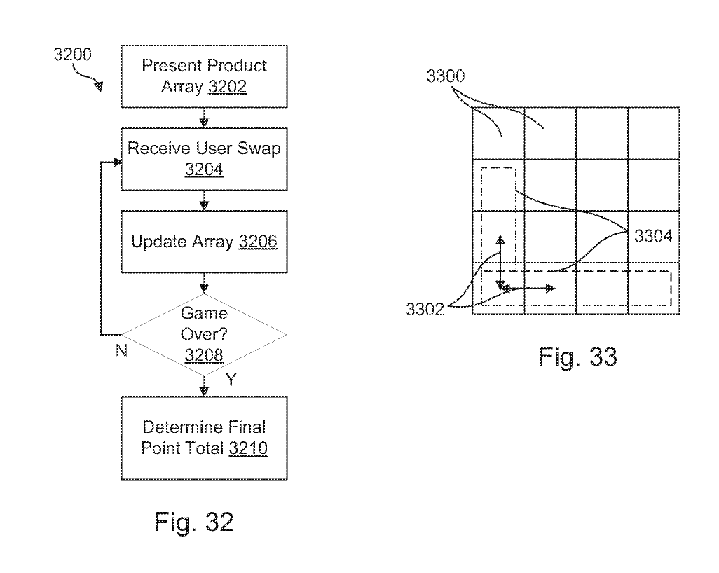

FIG. 32 illustrates a method 3000 for performing a matching game. As noted hereinabove with respect to other games and methods, the method 3200 may be preceded by the player selecting a number of products or selecting a brand with a number of products associated therewith. The game described with respect to the method 3200 may be provided as a game in the context of any of the methods described herein. The steps of the method 3200 may be performed on one or both of a player workstation 212 and the host server 202.

The method 3200 may include presenting 3202 an array of product images, some of which are identical. A player swap is then received 3204. Referring to FIG. 33, a swap is performed by two horizontally or vertically adjacent tiles 3300 trading places 3302 to create vertical or horizontal sets 3304 of contiguous identical product images. The objective of the swaps is to create rows and columns of identical product images. The likelihood of a player being awarded a promotion for a particular product may increase based on the number of contiguous instances of that product in a row or column.

After receiving 3204 a swap, the displayed product array 3206 is updated. The method 3200 may include evaluating 3208 whether the game is over, this may include receiving an input from the player indicating a desire to end the game. Alternatively, some other criteria may be used to end the game, such as expiration of a time limit or the achievement of a maximum possible number of matches. Upon ending the game, a final point total may be determined 3210. This may include assigning points based on the length of sets of contiguous identical product images. The points assigned to a row or column of identical images may depend on a point value assigned to the product depicted, which may depend on a rank assigned to the product by the player.

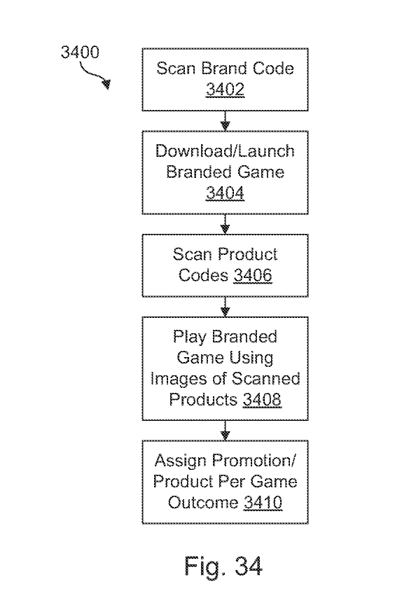

FIG. 34 illustrates a method for initiating and playing a product-based game using a smart phone or other device capable of scanning optical codes such as universal product codes (UPC), quick response (QR) codes, text labels, and the like. The steps of the method 3400 may be executed on a player workstation 212 or on a host server 202. The method 3400 includes scanning 3402 a brand code with the player workstation 212, such as using the camera of a workstation 212 embodied as a smart phone or other portable computing device. Other scanning devices, such as laser scanners may also be used. The brand code may be an optical code. The brand code may be unique to a retailer, manufacturer brand, or a specific ad campaign. Scanning of the brand code may trigger downloading and/or launching of a branded game 3404 corresponding to the retailer, brand, ad campaign, or the like associated with the brand code. In instances where the correct game is already downloaded this step may be omitted. In some embodiments, where the game is already downloaded on the player workstation 212, step 3404 may include downloading information sufficient to execute the game with content corresponding to the brand code.

A player may then scan 3406 product codes, such as by scanning optical codes affixed to products at a retail location or scanning some other type of display including optical product codes. Scanning 3406 may be done with a camera coupled to the workstation 212, or by means of some other scanner coupled to the workstation 212. The products that may be scanned and used for assigning promotions may be limited to a subset of all products available at a retail location in accordance with an ad campaign associated with the brand code. Scanning 3406 may be executed within the context of execution of the game launched or downloaded at step 3404.

A branded game may then be provided 3408 using images of the products scanned 3406 as one or both of interactive elements of the game interface and as a reward in the form of a promotion according to an outcome of the game. A promotion may then be assigned 3410 according to the game outcome according to any of the methods described herein. The promotion may be displayed on the user workstation 212 upon assignment and may include an optical code that may be scanned by a scanner, such as a laser scanner, at a point of sale (POS) device in order to redeem the promotion when purchasing the product associated with the promotion.

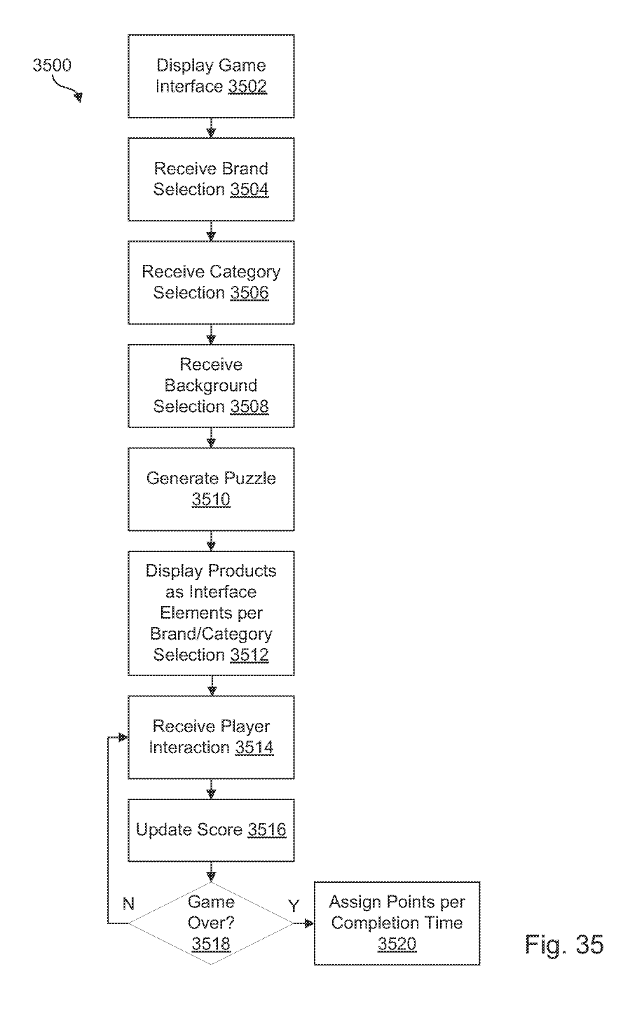

FIG. 35 illustrates a method 3500 for providing a branded product-based game. The steps of the method 3500 may be executed on a player workstation 212 or on a host server 202. The method 3500 may include presenting 3502 a game interface and receiving 3504 a brand selection from the player using the interface. The brand selection may identify a retailer, manufacturer, a particular product line, or group of products associated with a particular advertising campaign, or some other collection of products. The method may also include receiving 3506 a category selection that further limits the number of products that will be used. The category may be a sub-brand, product line, class of products (e.g., toys, kitchen tools, power tools, etc.), or any other subdivision of products. A player may also be permitted to select a background image. Accordingly, a background selection may also be received 3508. The options for the background selection may be determined by one or both of the brand selection 3504 and category selection 3508.

A puzzle may then be generated 3510 and displayed. The puzzle may be a conventional puzzle, such as a maze, or may be an interface to any type of game. Generating the puzzle may include displaying 3512 product images as interface elements in accordance with the brand and/or category selected at steps 3504, 3506 and displaying the selected background image. Player interaction with the interface may be received 3514 and a score updated 3516 according to the player interaction until it is found 3518 that the game is ended, either due to completion of a task, failure to complete a task, expiration of a time limit, or a player decision not to continue. Upon ending the game, points may be assigned 3520 according to a completion time or other metric of the player's performance. A promotion for a product associated with the selected brand and/or category may be assigned according to the methods described herein.

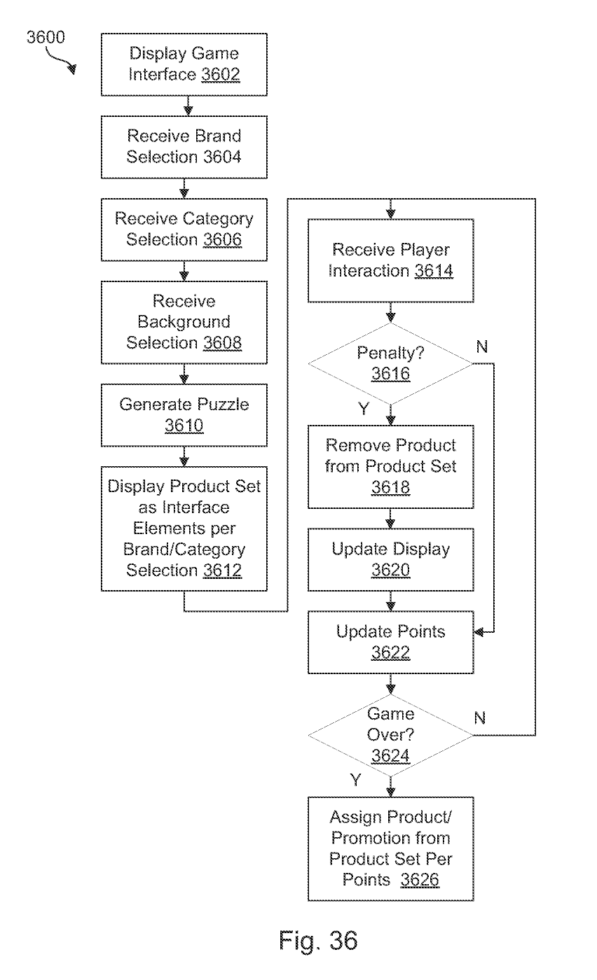

FIG. 36 illustrates another method 3600 for providing a branded product-based game. The steps of the method 3600 may be executed on one or both of a player workstation 212 and the host server 202. The method 3600 may include presenting 3602 a game interface and receiving 3604 a brand selection from the player using the interface. The brand selection may identify a retailer, manufacturer, a particular product line, or group of products associated with a particular advertising campaign, or some other collection of products. The method may also include receiving 3606 a category selection that further limits the number of products that will be used. The category may be a sub-brand, product line, class of products (e.g., toys, kitchen tools, power tools, etc.), or any other subdivision of products. A player may also be permitted to select a background image. Accordingly, a background selection may also be received 3608. The options for the background selection may be determined by one or both of the brand selection 3604 and category selection 3608.

A puzzle may then be generated 3610 and displayed. The puzzle may be a conventional puzzle, such as a maze, or may be an interface to any type of game. Generating the puzzle may include displaying 3612 images of products from a product set as interface elements in accordance with the brand and/or category selected at steps 3604, 3606 and displaying the selected background image. The product set may be determined according to the selection steps 3604, 3608 or may be individually specified by the player. Player interaction with the interface may be received 3614. The method 3600 may include evaluating 3616 the player interactions to determine whether to assess a penalty. For example, where the puzzle is a maze, products may be removed for wrong turns. If so, then a product is removed 3618 from the product set determined according to the selection steps 3604, 3606. The products may be removed randomly or more desirable products may be removed first. In some embodiments, a step is added whereby a player may rank potential products. In such embodiments products may be removed 3618 from a set of available products according to their ranks. The display may be updated to remove the image of the product removed from the product set. Following a player interaction, points may be assigned 3622 to a player's score (or subtracted) according to the game logic. If a game is found 3624 to have concluded, a product may be selected from those remaining in the product set and a promotion for the selected product may also be chosen. A game may end when there are no products left in the set, in which case the likelihood that no product will be awarded may be higher than if a product remained. A game may also end upon completing a task, failing to complete a task, expiration of a timer period, or a player input indicating intent to stop playing. Both the product and promotion may be selected according to methods described herein. If the game is not found 3624 to have ended another player interaction is received 3614 and the game continues.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The software code may also include scripting languages such Pearl, Python, PHP, and the like. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention, this is used for transitive and non-transitive storage. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state during transitive and non-transitive storage. The invention is not limited to any particular type of memory device, or any commonly used protocol for storing and retrieving information to and from these memory devices, respectively.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

What is claimed is:

1. A method for product-based gaming comprising:
receiving, at a host server, from a user computing device associated with a user, a user selection of one or more selected products from a product selection;
determining, at the host server, a game outcome according to user interactions with a game interface presented on the user computing device;
determining, at the host server, a probability of obtaining each product of the one or more selected products according to the game outcome;
randomly selecting, at the host server, a prize product from the one or more selected products according to the probability for each product;
transmitting, by the host server, to the user computing device, a promotional message identifying the prize product and a promotional offer.

2. The method of claim 1, further comprising:
determining, at the host server, a probability of one or more discount amounts according to the game outcome;
randomly selecting, by the host server, a discount amount of the one or more discount amounts according to the probability of each discount amount; and
including, by the host server, the discount amount in the promotional message.

3. The method of claim 1, wherein the game outcome includes a number of points.

4. The method of claim 3, further comprising:
adding, by the host server, the number of points of the game outcome to a player aggregate point total associated with the user associated with the user computing device;
selecting an aggregate product according to the aggregate point total;
transmitting to the user, by the host server, an aggregate prize message according to the player aggregate point total, the aggregate prize message identifying the aggregate product.

5. The method of claim 4, further comprising:
detecting, by the host server, posting on social media sites of a message by the user associated with the user computing device, the message relating to one or more of a game defined by the game interface and the one or more selected products; and
incrementing the player aggregate point total upon detecting the posting.

6. The method of claim 4, further comprising comparing the player aggregate point total for the user associated with the user computing device to a plurality of other player aggregate point totals;
wherein selecting the aggregate product further comprises selecting the aggregate product according to the comparison.

7. The method of claim 6, wherein receiving, at a host server, from the user computing device associated with the user, the user selection of one or more selected products from a product selection further comprises receiving a brand selection.

8. The method of claim 7, wherein determining, at the host server, the game outcome according to user interactions with the game interface presented the user computing device further comprises providing the game interface in the context of a time limited advertising campaign corresponding to the brand selection.

9. The method of claim 8, wherein the plurality of other player aggregate point totals are associated with the time limited advertising campaign.

10. The method of claim 1, wherein the game interface defines a game interface for a game selected from the group consisting of a dominos game, a matching game, a memory game, a sequence game, a slide game, a sokoban game, a Sudoku game, a relay game, and a maze game.

11. The method of claim 1, wherein the game interface includes images of the one or more selected product as interactive elements.

12. A method for product-based gaming comprising:
determining, on one of the host server and the user computing device, a game outcome according to user interactions with a game interface presented on the user computing device, the game interface including images corresponding to one or more selected products;
determining, on one of the host server and the user computing device, a probability of awarding each product of the one or more selected products according to the game outcome;
randomly selecting, on one of the host server and the user computing device, a prize product from the one or more selected products according to the probability for each product; and
displaying, on the user computing device, a promotional message identifying the prize product and a promotional offer.

13. The method of claim 12, further comprising:
determining, on one of the host server and the user computing device, a probability of one or more discount amounts according to the game outcome;
randomly selecting, on one of the host server and the user computing device, a discount amount of the one or more discount amounts according to the probability of each discount amount; and
including the randomly selected discount amount in the promotional message.

14. The method of claim 12, wherein the game outcome includes a number of points.

15. The method of claim 14, further comprising:
adding, on one of the host server and the user computing device, the number of points of the game outcome to a player aggregate point total associated with the user associated with the user computing device;
selecting, on one of the host server and the user computing device, an aggregate product according to the aggregate point total; displaying, on the user computing device, an aggregate prize message according to the player aggregate point total, the aggregate prize message identifying the aggregate product.

16. The method of claim 15, further comprising detecting, on one of the host server and the user computing device, posting on social media sites of a message by the user associated with the user computing device, the message relating to one or more of a game defined by the game interface and the one or more selected products; and
incrementing, by one of the host server and the user computing device, the player aggregate point total upon detecting the posting.

17. The method of claim 12, further comprising comparing, on one of the host server and the user computing device, the player aggregate point total for the user associated with the user computing device to a plurality of other aggregate point totals;
wherein selecting the aggregate product further comprises selecting, on one of the host server and the user computing device, the aggregate product according to the comparison.

18. The method of claim 17, further comprising receiving, at a host server, from the user computing device associated with the user, a brand selection, the one or more products corresponding to the brand selection.

19. The method of claim 18, wherein determining, at the host server, the game outcome according to user interactions with the game interface presented on the user computing device further comprises providing the game interface in the context of a time limited advertising campaign corresponding to the brand selection; and
wherein the plurality of other aggregate point totals are associated with the time limited advertising campaign.

20. The method of claim 12, wherein the game interface defines a game interface for a game selected from the group consisting of a dominos game, a matching game, a memory game, a sequence game, a slide game, a sokoban game, a Sudoku game, a relay game, and a maze game.

21. A method for product-based gaming comprising:
scanning, with a user computing device, optical product codes associated with one or more products;
determining, at one of a host server and the user computing device, a game outcome according to user interactions with a game interface presented on the user computing device, the game interface including images corresponding to the one or more products as interactive elements;
selecting a prize product according to the game outcome; and
displaying on the user computing device, a promotional message identifying the prize product and a promotional offer.

22. The method of claim 21, wherein the optical product codes are affixed to instances of the one or more products.

23. The method of claim 21, wherein scanning, with the user computing device, is performed using a camera incorporated in the user computing device.

24. The method of claim 21, further comprising scanning a brand code with the user computing device, the one or more products corresponding to the brand code.

25. The method of claim 24, wherein the brand code and optical product codes include optical codes selected from the group consisting of bar codes and quick response codes.

26. The method of claim 24, further comprising, in response to scanning the brand code with the user computing device, performing one or both of downloading a product-based game application and launching the product-based game application;
wherein the game interface is defined by the product-based game application.

27. The method of claim 21, further comprising:
displaying, on the user computing device, an optical promotional code encoding all or part of the promotional offer; and
scanning the optical promotional code by a point-of-sale device.

28. A method for product-based gaming comprising:
defining, on one of a host server and a user computing device, a product set including a plurality of products;
receiving, on the user computing device, user interaction with a game interface displayed on the user computing device to conduct a game, the game interface including images of the plurality of products within the product set;
according to the user interaction received, removing one or more products from the product set;
determining an outcome of the game;
selecting a prize product from products remaining in the product set according to the outcome;
displaying on the user computing device, a promotional message identifying the prize product and a promotional offer.

29. The method of claim 28, wherein selecting the prize product from products remaining in the product set according to the outcome further comprises:
determining, on one of the host server and the user computing device, a probability of awarding each product of the products remaining in the product set according to the outcome; and
randomly selecting, on one of the host server and the user computing device, a prize product from the products remaining in the product set according to the probability for each product.

30. The method of claim 28, further comprising:
determining, on one of the user computing device and the host server, a probability of one or more discount amounts according to the game outcome;
randomly selecting, on one of the user computing device and the host server, a discount amount of the one or more discount amounts according to the probability of each discount amount; and
including the discount amount in the promotional message.

31. The method of claim 28, further comprising receiving a brand selection on the user computing device;
wherein defining the product set further comprises populating the product set with products corresponding to the brand selection.

32. The method of claim 31, wherein the game interface includes a background image corresponding to the brand selection
